(19) United States
(12) Patent Application Publication
(10) Pub. No.: US 2025/0108331 A1
(43) Pub. Date: Apr. 3, 2025

(54) OFF-GRID TURBINE-DRIVEN CENTRIFUGAL REVERSE OSMOSIS SYSTEM, AND APPLICATIONS THEREOF

(71) Applicants: The Research Foundation for The State University of New York, Binghamton, NY (US); Cleveland State University Research Corporation, Cleveland, OH (US)

(72) Inventors: Cosan Daskirian, Endicott, NY (US); Mustafa Usta, Avon, OH (US)

(21) Appl. No.: 18/900,088

(22) Filed: Sep. 27, 2024

Related U.S. Application Data
(60) Provisional application No. 63/541,849, filed on Sep. 30, 2023.

(51) Int. Cl. B01D 61/10; B01D 61/08; B01D 63/16; C02F 1/44; C02F 103/08

(52) U.S. Cl. CPC B01D 61/10; B01D 61/08; B01D 63/16; C02F 1/441; B01D 2313/243; B01D 2313/246; B01D 2313/367; B01D 2313/70; B01D 2313/901; B01D 2315/02; C02F 2103/08; C02F 2201/009; C02F 2209/005; C02F 2209/03; C02F 2209/40; C02F 2303/10

(57) ABSTRACT

Integrated tidal desalination system that harnesses tidal power to produce drinkable water through a mechanically linked or direct drive integrated tidal turbine (ITT) and centrifugal reverse osmosis (CRO) system. The ITT-CRO system eliminates conversion losses in the power take-off unit by eliminating the need for electrical energy conversion. The ITT-CRO system is modelled, and the model used for control, and predictive maintenance.

### TECHNICAL FIELD

The present disclosure relates to an off-grid turbine-driven centrifugal reverse osmosis system, and applications thereof.

### BACKGROUND

Each reference cited herein is expressly incorporated herein by reference in its entirety, for all purposes.

As the global population increases and freshwater resources decline, desalination is becoming more important. But it's expensive and relies on electricity, making it challenging in remote areas without power grids. In areas with high demand for desalination but no access to a power grid, diesel generators are commonly used to power desalination units [5] due to their reliability and the belief that reverse osmosis (“RO”) technology requires electricity, according to the U.S. Department of Energy (“DOE”) Desalination report [4]. However, there is a need to shift towards renewable energy sources, in line with the “Powering Blue Economy” initiative [4]. Renewable energy is cost-effective, environment-friendly, and widely available, making it a viable solution for remote communities with limited access to electricity or high water supply costs. For coastal urban areas, renewable energy is also necessary for disaster relief as power outages due to disasters can contaminate drinking water wells.

While renewable energy sources such as wind and solar power are widely available, their intermittency and energy conversion losses require energy storage in desalination systems. Tidal power, on the other hand, is more predictable and consistent, potentially eliminating the need for energy storage. Wave and tidal technologies may have an advantage over solar or other renewables for islands with limited land resources. The greater predictability of tidal power also makes it easier to plan for energy generation and its use in desalination.

Desalination facilities must shift from conventional to renewable energy sources for sustainability.

Tidal current energy may be converted into electricity using a tidal turbine and generator, and then the generated electricity is utilized to operate the RO system. The modeling studies by National Renewable Energy Laboratory (NREL) for wave-energy systems indicate that direct pressurization of the desalination unit for water production could be more cost-effective compared to producing electricity to use in the desalination unit [3].

The state-of-art technology pressurizes the conventional RO unit through a high-pressure pump integrated into a rotating turbine shaft without intermediate electrical conversion.

For many communities globally that are dependent on desalination for their drinking water, the cost is a critical concern. In the United States, the capacity of the existing seawater RO market is approximately 500,000 m³/day, which translates to an annual electricity consumption cost of $45 million to $65 million [4]. The energy consumed by high-pressure pump operation accounts for around 25% to 40% of the total cost of desalinated water [5].

A major reason for the high cost of reverse osmosis desalination is the high pressure required to achieve a reasonable water recovery while overcoming the osmotic pressure differential (OPD) between saline water and fresh water. For example, for a typical seawater with a salt concentration of 35 g/L, the minimum transmembrane pressure (TMP) required to achieve a 50% total water recovery using conventional single-stage reverse osmosis (SSRO) is 56 bar.

Krantz et al., WO2021071435 “Reverse osmosis apparatus and method thereof” teaches a reverse osmosis unit having a housing. The reverse osmosis unit has a cylindrical drum disposed inside the housing and coupled to the housing in a manner so as to be rotatable relative to the housing about a longitudinal axis of the cylindrical drum, wherein a lateral gap between an exterior cylindrical surface of the cylindrical drum and the housing defines an intervening chamber. The cylindrical drum includes an outer cylindrical wall defining an interior cylindrical space of the cylindrical drum, and an inner cylindrical wall partitioning the interior cylindrical space into an inner cylindrical feed chamber encircled by the inner cylindrical wall and an outer annular separation chamber between the inner cylindrical wall and the outer cylindrical wall. The reverse osmosis unit further includes at least one channeling structure extending radially from the inner cylindrical wall of the cylindrical drum to the outer cylindrical wall of the cylindrical drum and sub-dividing the outer annular separation chamber into at least a permeate channel and a feed-flow-region, the at least one channeling structure defining the permeate channel therewithin, wherein a first channel end of the at least one channeling structure at the inner cylindrical wall is closed to separate the permeate channel from the inner cylindrical feed chamber and a second channel end of the at least one channeling structure is opened through the outer cylindrical wall to open the permeate channel into the intervening chamber, wherein the inner cylindrical wall has an opening for direct fluid communication between the inner cylindrical feed chamber and the feed-flow-region of the outer annular separation chamber. The at least one channeling structure includes a membrane element extending lengthwise along the at least one channeling structure from the inner cylindrical wall of the cylindrical drum to the outer cylindrical wall of the cylindrical drum, the membrane element being a semi-permeable interface between the permeate channel and the feed-flow-region of the outer annular separation chamber. The apparatus further includes a pump in fluid communication with the inner cylindrical feed chamber of the cylindrical drum of the reverse osmosis unit, the pump operable to pressurize the inner cylindrical feed chamber to be equal to or higher than an osmotic pressure of a feed for reverse osmosis. The apparatus further includes a motor coupled to the cylindrical drum of the reverse osmosis unit, the motor operable to rotate the cylindrical drum so as to continuously increase, via a centrifugal force generated, a pressure of the feed in the feed-flow-region of the outer annular separation chamber along the membrane element with increasing distance from the inner cylindrical wall of the cylindrical drum to the outer cylindrical wall of the cylindrical drum.

A reverse osmosis method separates a solvent from a feed. The method includes filling a cylindrical drum of a reverse osmosis unit of a reverse osmosis apparatus with the feed in a manner such that an inner cylindrical feed chamber of the cylindrical drum and a feed-flow-region of an outer annular separation chamber of the cylindrical drum is filled up with the feed. The method further includes rotating the cylindrical drum relative to the housing, via a motor of the reverse osmosis apparatus coupled to the cylindrical drum, to continuously increase, via a centrifugal force generated, a pressure of the feed in the feed-flow-region of the outer annular separation chamber along the membrane element with increasing distance from the inner cylindrical wall of the cylindrical drum to the outer cylindrical wall of the cylindrical drum.

Tikalsky, U.S. Pat. Nos. 10,689,270, 11,459,249, US20200290897, and US20200017378 “Centrifugal Reverse Osmosis System”, disclose a reverse osmosis system which includes a wheel formed of a hollow central hub, radial tubes fluidly connected to the central hub, semi-permeable membranes provided in each radial tube, a permeate outlet tube, and a concentrate outlet tube; a permeate collection tank; a concentrate collection tank; and a drive mechanism. The drive mechanism rotationally drives the wheel while the source liquid is supplied to the central hub of the wheel, the rotation causing the source liquid to enter the radial tubes in radially outward directions and cause pressure increase on the source liquid in the radial tubes. The pressure increase forces the source liquid through the semi-permeable membranes to separate into permeate and concentrate, the permeate being directed to the permeate collection tank through the permeate outlet tube and the concentrate being directed to the concentrate collection tank through the concentrate outlet tube.

Lechuga Andrade et al, U.S. Pat. No. 9,573,098 and US20140021134 “Filter And Method For The Desalination Of Water By Means Of Reverse Osmosis Of The Centrifugal Type, Involving The Generation Of Dean Vortices”, disclose a method for desalination of sea water and a design and construction of a centrifugal filter for desalination of water. The process uses the filter developed based on reverse osmosis technology as a fundamental component that uses hollow fiber membrane modules arranged in a spiral manner around a central support pipe and distributed in concentric rings around the periphery of the rotating section to favor the formation of Dean vortices.

Cook, U.S. Pat. No. 7,686,965 “Centrifugal Fluid Filtration Devices, Systems And Methods”, discloses fluid filtration devices, systems and methods. The device comprises, for example, an influent feed tube; an influent receiving bowl in fluid communication with the influent feed tube; and a plurality of radial arms having filters therein configured to rotate about an axis within the influent receiving bowl. The fluid filtration devices, which can be configured to filter a wide variety of fluids, comprises: an influent feed tube; an influent receiving bowl in fluid communication with the influent feed tube; and a plurality of radial arms having filters therein configured to rotate about an axis within the influent receiving bowl. Additionally, methods are provided for obtaining an influent from a target source of fluid to be filtered; filtering the influent in a first filtration step; filtering the influent in a second filtration step upon receiving effluent from the first filtration step by transferring influent through a plurality of radial arms by rotating the radial arms having filters disposed therein about an axis in a filtration unit; and emitting a final filtered fluid effluent.

Coull, et al., U.S. Pat. Nos. 7,354,515, 7,740,760, 7,803,279, 8,012,351, and 8,696,905 “Fluid Concentrator”, discuss a fluid concentrator, particularly a plasma component out of blood, for treatment of a patient. The concentrator apparatus includes a main housing defining a centrifuge chamber, that also holds the filter. The concentrator allows viewing of the fluid after centrifuging, with an outlet port positionable at a height corresponding to the level of the fraction of the fluid to be further concentrated. Once the fluid is centrifuged, a portion of the fluid is drawn through the outlet, and then pressured past the filter to further concentrate the fluid using the same vessel as used for centrifuging. The same plunger is preferably used to draw centrifuged fluid from the centrifuge chamber to pressure the centrifuged fluid past the filter.

Forman, U.S. Pat. No. 7,182,866 “Apparatus And Method For Separating Impurities From A Stream”, discloses a filtration apparatus and method for filtering a stream. The apparatus comprises a rotor that contains an inlet for the stream and an array of cavities operatively arranged to receive the stream from the impeller. The rotor member further includes membranes, operatively positioned within the array of cavities, for separating the impurities from the stream, and a permeate outlet for delivering a permeate from the rotor. A drive member is included to rotate the rotor so that the stream is exposed to a centrifugal force. In one preferred embodiment, the rotor contains a baffle plate to distribute the stream about the inner portion and an impeller vane adapted to receive the stream.

Mayer et al., U.S. Pat. No. 7,160,469 “System And Method For Efficient And Low Energy Desalination Of Water”, discloses a system and method for efficient and low energy sweetening of water, based on borderline fast fluctuation between liquid to gaseous state and back, by using centrifugal forces to make water droplets fly at a high speed, so that they evaporate for a split second, the salt is separated, and they condense again.

Hopkin, et al., U.S. Pat. No. 6,132,613 “Centrifugal Reverse-osmosis Desalination Unit Incorporating An Annular Membrane Cartridge”, discloses an apparatus for separating an original feed solution such as seawater into a product solution of decreased concentration (relatively fresh water) and an exhaust solution of increased concentration. The apparatus includes an annular reverse osmosis membrane, contained in an annular pressure vessel that is housed in a rotor assembly. The rotor is arranged to spin on an axle and is located within an evacuated shroud. The apparatus further includes a supply for supplying the original feed solution to the reverse osmosis membrane, exhaust means at an outermost radius of the reverse osmosis membrane for removing the exhaust solution from the reverse osmosis membrane, a product removal port at an innermost radius of the reverse osmosis membrane for removing the product solution from the reverse osmosis membrane and a pump for creating a pressure differential across the reverse osmosis membrane to separate the original feed solution into the product solution and the exhaust solution. The supply and exhaust are relatively axially and radially spaced such that the feed solution travels along a combined radial and axial flow-path.

Wild et al., U.S. Pat. No. 4,886,597 “Centrifugal Reverse-osmosis Desalination Unit”, discloses a desalination apparatus for removing salt from seawater. The apparatus operates on the principle of reverse-osmosis whereby a feed solution containing seawater is separated into a product solution of decreased salt concentration and an exhaust solution of increased concentration. An evacuated enclosure is included to reduce windage losses and power consumption.

Stover, U.S. Pat. No. 11,667,549 “Osmotic Methods And Systems Involving Energy Recovery”, discloses liquid solution concentration methods and related systems involving osmosis units and energy recovery. In some embodiments, an osmotic system has a pump, a first reverse osmosis unit, a second reverse osmosis unit, and one or more energy recovery devices. Various embodiments are directed to features such as balancing streams, recirculation streams, and/or valving that alone or in combination may afford improved energy efficiency and/or system performance. Some embodiments may improve performance of certain types of energy recovery devices in combination with osmosis units, such as isobaric or turbine energy recovery devices.

Manz et al., US20220314169 “Reverse Osmosis Centrifuge” discloses a reverse osmosis centrifuge which converts rotational energy into fluid velocity and conserves the energy placed into the concentrate. As concentrate travels back towards the center of the reverse osmosis centrifuge, the velocity of the fluid is converted into rotational force, thus conserving energy. To accomplish this, the reverse osmosis centrifuge includes a stationary cylindrical housing having a vacuum chamber and a vacuum pump for generating vacuum pressure in the vacuum chamber, a driveshaft coupled to a membrane cylinder rotatable within the stationary cylindrical housing, the membrane cylinder having a plurality of vertical desalination membranes, and an energy recovery turbine. The reverse osmosis centrifuge can be placed on the concentrate or waste stream outlet of a desalination or reverse osmosis facility to increase freshwater production.

Choong et al., U.S. Pat. No. 11,400,416 “Osmotic Desalination Methods And Associated Systems”, disclose osmotic desalination methods and associated systems. Multiple osmotic membranes may be used to perform a series of osmosis steps, such that an output stream having a relatively high water purity-compared to a water purity of an aqueous feed stream—is produced. Multiple draw streams can be used to produce aqueous product streams having sequentially higher purities of water. Certain embodiments are related to osmotic desalination systems and methods in which forward osmosis is used to produce a first product stream having a relatively high water purity relative to an aqueous feed stream, and reverse osmosis is used to perform a second step (and/or additional steps) on the first product stream. Multiple reverse osmosis steps can be used in series to perform a net desalination process.

Lee, U.S. Pat. No. 9,168,493 “Waste Water Treatment System” discloses a CRO system in which rotation of the apparatus generates centrifugal force and/or takes advantage of the Coriolis effect to push the waste water to be filtered through the filtration material or membrane in filter modules and separate the liquid from the particulate matter. Thus, the rotation of the apparatus (including the fine filtration devices) can work in conjunction with the Coriolis effect to increase the pressure differential and/or rate of flow of influent across the inner surface of the fine filtration devices and/or membrane.

Lee, U.S. Pat. No. 8,048,307 “Dynamic Filtration Device Using Centrifugal Force” and U.S. Pat. No. 8,308,953 “Methods Of Dynamic Filtration Using Centrifugal Force And Methods Of Making A Dynamic Filtration Device” disclose a filtration system having one or more apparatuses for filtering gases, liquids, or fluids (e.g., water) to remove particulate matter, and methods of making and using the apparatus. More particularly, embodiments relate to apparatuses and methods for applying centrifugal force(s) to push a fluid or gas to be filtered through a porous membrane or filter within the apparatus to separate particulate matter therefrom. It takes advantage of the Coriolis effect within a cylindrical filter radiating out from a rotating central body. The filtration apparatus provides an energy efficient system for microfiltration (or other filtration processes) to remove contaminants from gases and fluids, such as waste water.

Marelius, US20110247989 and U.S. Pat. No. 8,778,191 “Filtering Device And A Method Of Filtering A Fluid” disclose a centrifugal filtering device for filtering a fluid. The device comprises a rotatable inner casing forming an inner space and a rotatable outer casing forming an outer space. The device further comprises a fluid inlet, at least one filter and drive means. The drive means is configured to rotate the inner casing to create a centrifugal pressure. The pressure forces a part of the fluid contained in the inner space through the filter and to a radially outer position of the outer space. The filtered fluid forms a filtrate, the filtrate having a kinetic energy. The outer casing is configured to transport the filtrate from the radially outer position to a radially inner position of the outer space, permitting transfer of the kinetic energy from the filtrate to the outer casing, thereby permitting regaining of mechanical energy.

Hanak, U.S. Pat. Nos. 6,277,265 and 5,858,199 “Apparatus And Method For Electrocoriolysis, The Separation Of Ionic Substances From Liquids In The Electrodynamic Mode” disclose an apparatus and method for electrocoriolysis, the separation of ionic substances from liquids in the electrodynamic mode. The method maximizes centrifugal forces on a fluid contained in a chamber having oppositely polarized electrodes. A feed fluid is fed into the chamber. Spacing of the electrodes can be minimized for enhancement of the process. A constant voltage can be applied. Centrifugal force and the electric potential across the chamber create enhanced separation. Concentrated solution can be removed from a location in the chamber and depleted solution from another location.

Siwecki et al., U.S. Pat. No. 4,333,832 “Rotating Solution Separation System”, discloses a rotating structure in which salt water and other solutions are accelerated and applied to a cannister containing reverse osmosis membrane material. The desalinated water is removed after passing through the large surface area concentration of membrane material in the cannister. The enriched brine is removed from the cannister at a point furthest from the axis of the rotating structure and returned to the vicinity of the axis to prevent the buildup of dense material. The membrane material is configured in the cannister so that the flow is generally radial with respect to the axis of the rotating structure.

Grenci, U.S. Pat. No. 3,400,074 “Centrifugal Reverse Osmosis For Desalination” discloses an apparatus and process for desalination wherein salt water is introduced inside a rotating cylindrical semipermeable membrane so that pure water passes through the membrane under centrifugal force. Pressure induced separation of multicomponent admixtures is achieved using semi-permeable separators or membranes. More particularly, a process and an apparatus provides the requisite pressure to accomplish the separation of at least one of the components from a multicomponent admixture using a semipermeable separator or membrane.

Berriman, U.S. Pat. No. 3,669,879, “Fluid Separation Apparatus And Method”, relates to a separation process of the reverse osmosis type useful for generating fresh water by forcing salt water against a semipermeable membrane that allows only pure water to pass, which uses centrifugal forces created by rotating basket to build up a pressure head of water supplied to the basket to force water through the membrane. The pure water can be expelled by a nozzle in a direction to help rotate the basket. The membrane can be in the form of a spiral or layers extending perpendicular to the axis, to increase the membrane area within a basket of given size. The membranes can extend radially with respect to the axis of rotation, and supply and removal conduits can be positioned to continually flow water in an outward radial direction to prevent the build-up of polarization layers on the membrane surfaces.

Keefer, U.S. Pat. No. 4,230,564, “Rotary Reverse Osmosis Apparatus And Method”, relates to a reverse osmosis or ultrafiltration apparatus having first and second rotors revolving in the same direction about a central axis. The first rotor revolves at a higher speed and has an impeller which serves as a feed pump for the feed fluid. The second rotor revolves at lower speed and has a pressure vessel containing semi-permeable membranes which selectively permeate one component of a feed fluid, and has an integral diffuser casing for the feed pump. This arrangement reduces disc friction and diffuser hydraulic losses compared to conventional centrifugal machinery with stationary casings. The membranes are arranged so that centrifugal action within the rotating membrane assembly inhibits fouling and concentration polarization by differential buoyancy effects. The impeller can be a centrifugal type with an externally surrounding diffuser, or it can be in an external impeller type enclosing a pitot tube pump type diffuser. Some embodiments include a centripetal energy recovery turbine for the concentrate fluid rejected by the membranes, the turbine runner being mounted on the first rotor remote from, or integral with, the impeller. Alternatively concentrated fluid energy can be recovered by using tangentially disposed nozzles mounted on the second rotor to discharge fluid backwards. Permeate fluid energy can be recovered from permeate nozzles ejecting permeate fluid against an impulse turbine mounted on a third rotor journalled to rotate about the axis at a speed of about one-half of the speed of the second rotor.

Loeffler and Bradbury, U.S. Pat. No. 3,567,030, “Reverse Osmosis Apparatus”, relates to an apparatus for carrying out reverse osmosis to separate materials, the apparatus including an outer shell and an inner shell mounted inside the outer shell for rotation of the shells about a common axis. The inner shell includes a permeable osmotic membrane at its outer periphery which is located radially inwardly of an axially extending space between the shells. There are further provided spaces between the opposed ends of the inner and outer shells through which a process solution may be directed radially to and from the axially extending space. A conduit and fluid flow passageway system are provided for removing product liquid from a point immediately radially inward of the membrane and at one end of the inner shell whereby when the shells are rotated about a common axis, a pressure differential is developed across the membrane in which the lower pressure is on the radially inner side of the membrane.

See also, Patents and Published Application Nos. CA1102711; CA1290700; CA2178118; CN103880120; CN109319887; CN112601601; DE2007474; DE2352833; DK158201; FR2035698; FR2116612; FR2153334; FR2181567; GB1112550; GB1393547; GB1417973; GB1603746; GB1603747; GB2107404; JPH0518634U; KR101666338; U.S. Pat. Nos. 11,174,877; 11,459,249; 1,257,235; US20040089605; US20070278146; US20070289904; US20100202870; US20200391158; US20220314169; U.S. Pat. Nos. 3,193,105; 3,355,382; 3,400,074; 3,437,208; 3,456,802; 3,491,021; 3,493,495; 3,493,496; 3,498,910; 3,505,215; 3,536,612; 3,567,030; 3,637,081; 3,669,879; 3,676,335; 3,756,408; 3,786,924; 3,838,774; 3,839,201; 3,840,121; 3,856,676; 3,992,301; 4,002,567; 4,169,789; 4,200,530; 4,230,564; 4,230,564; 4,333,832; 4,717,485; 4,790,942; 4,886,597; 4,973,408; 4,983,305; 5,082,428; 5,137,637; 6,132,613; U.S. Pat. Nos. 6,139,740; 6,713,028; 6,797,173; 8,025,157; 9,573,098; 9,695,064; WO1988001899; WO1998036823; WO2000043096; WO2012108754; WO2013018036; WO2020014645; and WO2023158503.

### SUMMARY OF THE INVENTION

The embodiments of the integrated tidal desalination system featured herein may harness tidal (or other hydraulic or pneumatic) power to produce drinkable water through an integrated tidal turbine (ITT) and centrifugal reverse osmosis (CRO) system (ITTCRO) [1,2]. These systems eliminate conversion losses in the power take-off unit by eliminating the need for electrical energy conversion. Tidal power is a reliable and stable energy source that may eliminate the need for energy storage, unlike solar and wind power. CRO utilizes minimal energy based on theoretical calculations.

In order to obtain further benefits, a hybrid system may provide a generator to obtain electrical power from the tidal turbine, generally surplus to the needs of the CRO. The system may further include an energy storage system, which may be a battery, elevated water reservoir, flywheel, or other electrical, mechanical, or chemical energy storage system. Further, the system may include a power assist for the CRO from stored or grid-supplied energy, where the tidal flows or other input are insufficient to meet the demand. However, these ancillary structures are preferably in addition to, and not in replacement of, the mechanical linkage between the ITT and CRO, and may be optional add-ons to a basic system. On the other hand, the various technologies disclosed herein need to be used only within an ITTCRO.

The conventional reverse osmosis (RO) method is widely used to obtain drinkable water from seawater, but most of the membrane module operates at pressures higher than the thermodynamic minimum energy required under ideal conditions.

Further features and advantages of the disclosure, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

It is therefore an object to provide a desalination system, comprising: a turbomachine, configured to convert fluid flow into an axial rotation; and a centrifugal reverse osmosis module mechanically coupled to the turbomachine, configured to separate water from salt based on the axial rotation.

A gearbox or transmission may be provided to couple the turbomachine to the centrifugal reverse osmosis module.

The centrifugal reverse osmosis module may comprise a stationary or rotating disk membrane, with a single or multiple membranes within the module.

An automated control may be provided to automatically regulate a rotational speed of the CRO module, a water flow into the turbomachine, a desalinization rate, a pressure within the CRO, storage of extra energy from the turbomachine, supply of extrinsic energy to the CRO to supplement the turbomachine, or the like, and combinations and subcombinations thereof.

The turbomachine may comprise a tidal turbine, the system further comprising an automated control configured to control a water flow through the tidal turbine. The turbomachine may comprise a plurality of turbine blades, further comprising an automated control configured to control a pitch of plurality of turbine blades. The control may alter a baffle for water entry into the turbomachine, a bypass ratio of water entering an inlet and passing through the turbomachine, or the like.

A pump may be provided to pressurize water having a salt concentration to be desalinated by the desalination system to an osmotic pressure required based on the salt concentration. The pump may be driven by the turbomachine, separately from the turbomachine, by a different turbomachine, or using a separate source of power.

It is another object to provide a desalination method, comprising: supplying a fluid flow to a turbomachine and converting the fluid flow into an axial rotation; and spinning a centrifugal reverse osmosis module with mechanical power from axial rotation from the turbomachine, to osmotically desalinate salt water. The method may further comprise altering a ratio of the axial rotation of the turbomachine and a rotational rate of spinning of the centrifugal reverse osmosis module with a gearbox, automatically controlling a rotational speed of the centrifugal reverse osmosis module, and/or automatically controlling a rate of the fluid flow through the turbomachine.

The turbomachine may comprise pitched blades, the method further comprising automatically controlling a pitch of the blades of the turbomachine.

The method may further comprise pressurizing the salt water entering the centrifugal reverse osmosis module using a pump, to pressurize the salt water to a pressure above 3 bars and below an osmotic pressure of the salt water. The method may further comprise spinning the centrifugal reverse osmosis module to raise a pressure of the salt water to a pressure at or above the osmotic pressure of the salt water, based on a desired water recovery rate.

It is a further object to provide a desalination system, comprising: a turbine configured to transform fluid flow into a rotation about an axis; a centrifugal reverse osmosis module configured to spin in response to the rotation about the axis and achieve a desalinated water flow through a desalination reverse osmosis membrane dependent on the spin; and a mechanical transmission configured to transfer mechanical power from the rotation about the axis of the turbine to spin the centrifugal reverse osmosis module.

An automated control may be provided, configured to control the rotational speed of the centrifugal reverse osmosis module in response to the fluid flow.

A prefiltration system may be provided, configured to receive salt water having solid particulates and to produce a filtrate having reduced solid particulates with respect to the received salt water using power from the fluid flow.

The turbine may have an inlet pressure, the system further comprising a vessel configured to store fluid having a pressure above the inlet pressure using excess power from the turbine, and to release a flow of the stored fluid when the inlet pressure is insufficient to achieve a desired water recovery rate.

The desalination system may have a rotational axis of spinning of the centrifugal reverse osmosis module which is perpendicular to the axis of the turbine.

It is another object to provide a desalination method, comprising: spinning a turbine based on tidal flows of seawater; and spinning a centrifugal reverse osmosis membrane mechanically linked to the turbine, to achieve sufficient pressure derived from centrifugal force at a portion of the centrifugal reverse osmosis membrane to achieve reverse osmosis.

It is also an object to provide a desalination system, comprising: a tidal turbine; and a centrifugal reverse osmosis module that separates water from salt coupled to the tidal turbine, wherein the tidal turbine is mechanically linked to the centrifugal reverse osmosis module to provide a centrifugal force from rotation of the tidal turbine.

The desalination system may further comprise a gearbox or continuously variable transmission that couples the centrifugal reverse osmosis module to the tidal turbine.

The centrifugal reverse osmosis module may include a single disk membrane or a plurality of disk membranes.

The desalination system may comprise an automated control configured to control a rotational speed of the centrifugal reverse osmosis module, a water flow through the tidal turbine, a pitch of turbine blades of the tidal turbine, and/or a flow rate of feed through the centrifugal reverse osmosis module.

The desalination system may include a pump integrated to the turbine to pressurize the incoming salty water to an osmotic pressure, which depends on the salt concentration of the feed, to initiate the permeation at the system's entry point.

The tidal turbine may be configured to spin the centrifugal reverse osmosis module to raise the pressure of the water to the levels dictated by the salinity and water recovery rate of the feed.

The desalination system may further comprise a pressurizing pump configured to pressurize the water to be desalinated to a first pressure (i.e., osmotic pressure), and the tidal turbine is configured to spin the centrifugal reverse osmosis module to raise a pressure of the water to be desalinated at a periphery of the centrifugal reverse osmosis module to a second pressure, the second pressure being higher than the first pressure.

It is also an object to provide a desalination method, comprising: supplying a tidal flow to a tidal turbine; and spinning a centrifugal reverse osmosis module with mechanical power from the tidal turbine to osmotically desalinate salt.

A gearbox may be provided between the tidal turbine and the centrifugal reverse osmosis module to alter a rotational rate. The gearbox may have a single ratio, a plurality of selectable ratios, or a continuous range of ratios.

A rotational speed of the centrifugal reverse osmosis module may be controlled by a mechanical, hydraulic, or electronic/electromagnetic controller. The controller may be a feedback controller, with proportional, proportional-differential, or proportional-integral-differential control. The controller may be adaptive. The controller may be model-based. The controller may comprise a machine learning module, such as a neural network.

The desalination method may further comprise pressurizing water to be desalinated entering the centrifugal reverse osmosis module with a pump to the osmotic pressure of feed for the centrifugal reverse osmosis module. The pump may be configured to pressurize the water to be desalinated up to 28 bars which is the osmotic pressure for seawater with 35 g/L concentration.

The desalination method may further comprise spinning the centrifugal reverse osmosis module with the tidal turbine to raise the pressure of the water to be desalinated to the required pressure levels within the centrifugal reverse osmosis module.

It is also an object to provide a desalination system, comprising: a turbine configured to transform tidal flow into a rotation about an axis; and a centrifugal reverse osmosis module configured to spin in response to the rotation about the axis, wherein the turbine is mechanically linked to the centrifugal reverse osmosis module.

The desalination system may further comprise an automated control configured to control a rotational speed of the centrifugal reverse osmosis module.

The desalination system may further comprise a prefiltration system, configured to receive water having solid particulates and to produce a filtrate having reduced solid particulates with respect to the received water. The received water may be seawater or brackish water with a lower salt concentration. The received water may be pressurized by rotational energy from the turbine. The received water may be pressurized by a pump driven by the turbine.

The turbine may be mechanically linked to the centrifugal reverse osmosis module through a belt, v-belt or a spur gear. The turbine is mechanically linked to the centrifugal reverse osmosis module through a fixed ratio gear, selectable variable ratio gear transmission, and/or a continuously-variable transmission.

A rotational axis of the centrifugal reverse osmosis module may be coaxial, parallel or inclined with respect to the axis of the turbine.

The centrifugal reverse osmosis module may spin at a faster rate than the turbine.

A control system may be provided configured to control a rotational speed of the turbine, a rotational speed of the centrifugal reverse osmosis module, and/or a ratio of a rotational speed of the centrifugal reverse osmosis module with respect to a rotational speed of the turbine.

The desalination system may further comprise an energy storage system configured to maintain a rotational speed of the centrifugal reverse osmosis module over variations in tidal flow.

The desalination system may further comprise a sensor configured to determine performance of the centrifugal reverse osmosis module and/or to determine a need for maintenance of the centrifugal reverse osmosis module.

### BRIEF DESCRIPTION OF THE DRAWINGS

FIGS. 1A-1C show schematics of the main components of the desalination systems using tidal energy: (FIG. 1A) baseline 0 using electricity generated by the turbine to operate conventional RO, (FIG. 1B) baseline 1 (state-of-art) using the shaft power of turbine to pressurize conventional RO through a high-pressure pump and (FIG. 1C) ITTCRO technology using the shaft power to rotate conventional high-pressure pump and innovative CRO module.

FIGS. 2A and 2D show instantaneous contours of normalized velocity magnitude.

FIGS. 2B and 2E show instantaneous contours of normalized vorticity in the z-direction.

FIGS. 2C and 2F show instantaneous contours of iso surfaces of vortical structures, normalized Q-criterion (QU_{∞}²/Dₜ²=700) after 7 turbine revolutions.

FIG. 3 shows the diameter of the CRO module as a function of rotation speed at different pressure values on the membrane surface.

FIG. 4A shows a schematic of the proof-of-concept setup.

FIG. 4B shows an exploded view of the CRO module.

FIG. 4C shows a cross-section of the CRO.

FIG. 5A shows a schematic of another potential design for the CRO module.

FIG. 5B shows a single membrane disk.

### DETAILED DESCRIPTION OF THE PREFERRED EMBODIMENTS

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

The ITTCRO technology, converts ocean current and tidal energy into desalinated water by integrating hydrokinetic turbine to CRO. This eliminates the need for electricity generation, thus reducing energy use and associated carbon emissions in desalination, for a fossil fuel electricity source. The ITTCRO technology also simplifies the design. Furthermore, this new approach is expected to increase marine energy utilization efficiency for desalination, resulting in higher water production with the same amount of marine energy.

The conventional RO results in elevated energy expenses due to pressurizing the feed to the levels required for the desired water recovery rate. The recovery rate is defined as the ratio of the flow rate of the produced desalinated water to the flow rate of the feed seawater. With the CRO technology, this cost can be reduced by operating RO at a gradually increasing pressure dictated by thermodynamic equilibrium for the local transmembrane salt-concentration difference. The idealized calculations showed that, as compared to the conventional RO, CRO can reduce the gross specific energy consumption (SEC_{gross}) by 15% and net specific energy consumption (SECₙₑₜ) by 31% for a potable water recovery rate of 50% at 56 bar from a 35 g/L seawater feed [1]. The distinction between SEC_{gross} and SECₙₑₜ lies in the adoption of an energy recovery device for SECₙₑₜ.

The pilot-scale experiments [6], which were conducted to study energy-efficient reverse osmosis (EERO), revealed that the measured values were in agreement with the idealized calculations within a 20% margin of error.

The CRO unit may be operated near thermodynamic equilibrium using dynamic torque output from the tidal turbine. By considering the reduction of the energy consumption with CRO as compared to conventional RO, water production cost will be decreased.

Pre- and post-filtration stages also require energy in both conventional RO and CRO units, but several orders of magnitude less than the primary membrane separation process [4]. Operating the system in locations with low turbidity and suspended solids, or with a Silt Density Index (SDI) below 3%/min, can eliminate the need for prefiltration and minimize membrane fouling in RO [8]. The system can also be operated in tidal streams with higher SDI by integrating a pre-treatment apparatus to the runner shaft.

The ITTCRO technology operates by using the direct rotation of a tidal turbine's rotor shaft to drive a CRO module, eliminating conversion losses and improving the system's compactness. Additionally, the ITTCRO system can operate in regions with varying tidal streams, accommodating unpredictable water flow without energy storage and relying solely on instantaneous water stream speed for water production. This reliance on stream speed may result in a reduction in water recovery rates of up to 10% in instances of lower tidal streams.

While a 10% water recovery may seem small for large-scale desalination plants, it can be useful for producing water in remote communities or for disaster relief purposes. On the other hand, the water recovery may exceed 50%, similar to existing RO technologies, however with lower energy usage.

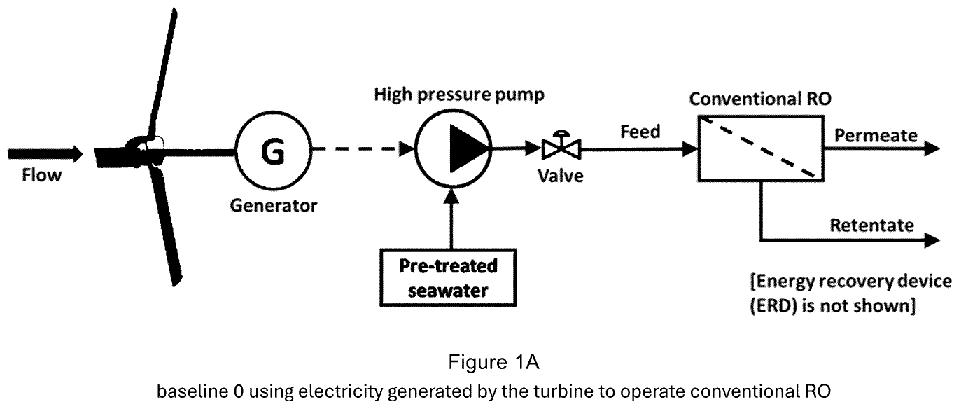

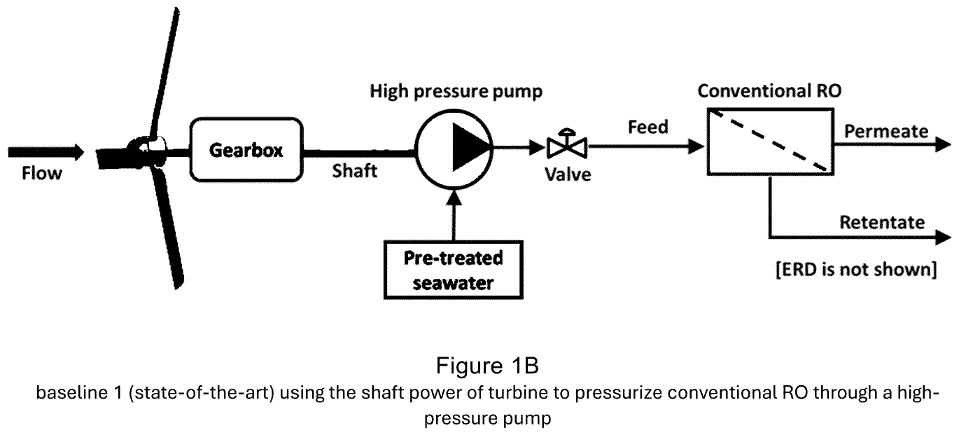

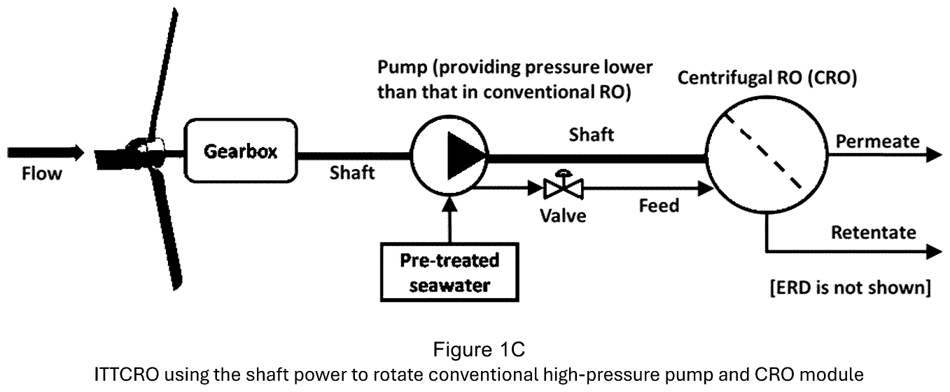

In each of the technologies in FIGS. 1A-1C, the turbine converts the kinetic energy of the tidal stream to mechanical power.

In ‘baseline 0’, the mechanical power is converted to electricity via a generator and then the electricity is used to operate a high-pressure pump for a conventional RO unit. For the sake of clarity, the energy recovery device (ERD) is not shown in the desalination systems presented in FIGS. 1A-1C.

In ‘baseline 1’, rather than generating electricity, the mechanical power is directly used to rotate the high-pressure pump through a coupling shaft. Pumps need a higher rotation speed than the tidal turbine, so a gearbox is employed. Similar to ‘baseline 0’, the high-pressure pump in ‘baseline 1’ pressurizes the conventional RO unit that runs far from thermodynamic efficiency.

The ITTCRO technology centers on a continuously operating CRO unit that gradually increases transmembrane pressure in the radial direction. The CRO unit is powered directly by the tidal turbine through a shaft without energy conversion. The feed is pressurized to the level of osmotic pressure by coupling a pump to the turbine shaft. The pump provides pressure levels (i.e., osmotic pressure) lower than those typically found in conventional RO systems in ‘baseline 0’ and ‘baseline 1’. Additional pressure will build up within the CRO due to centrifugal force, facilitating the separation of permeate flux across the membrane.

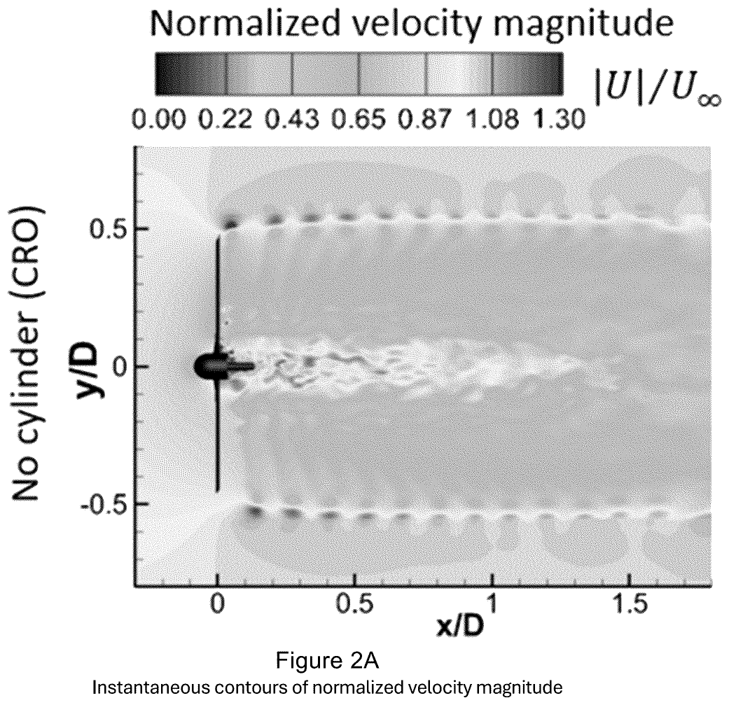

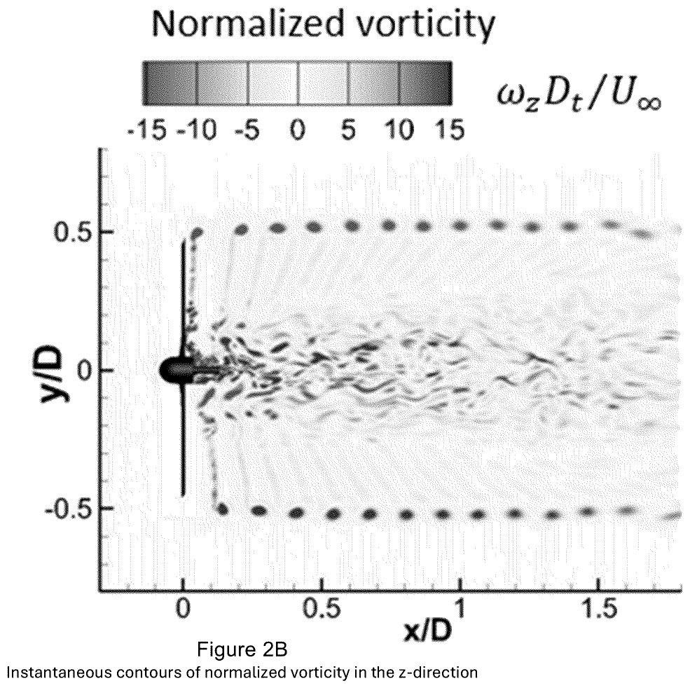

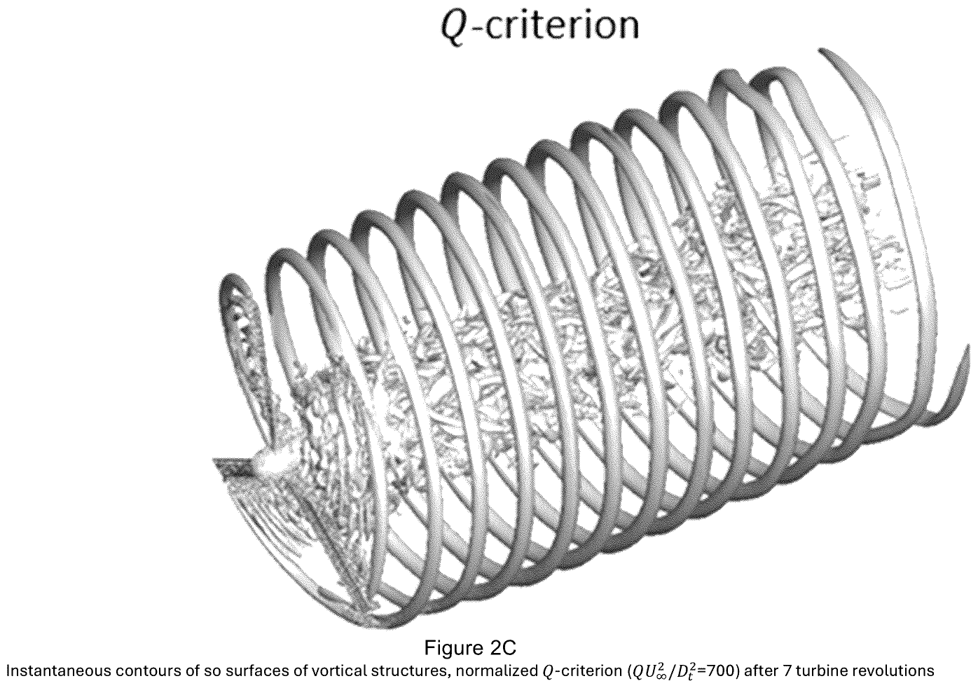

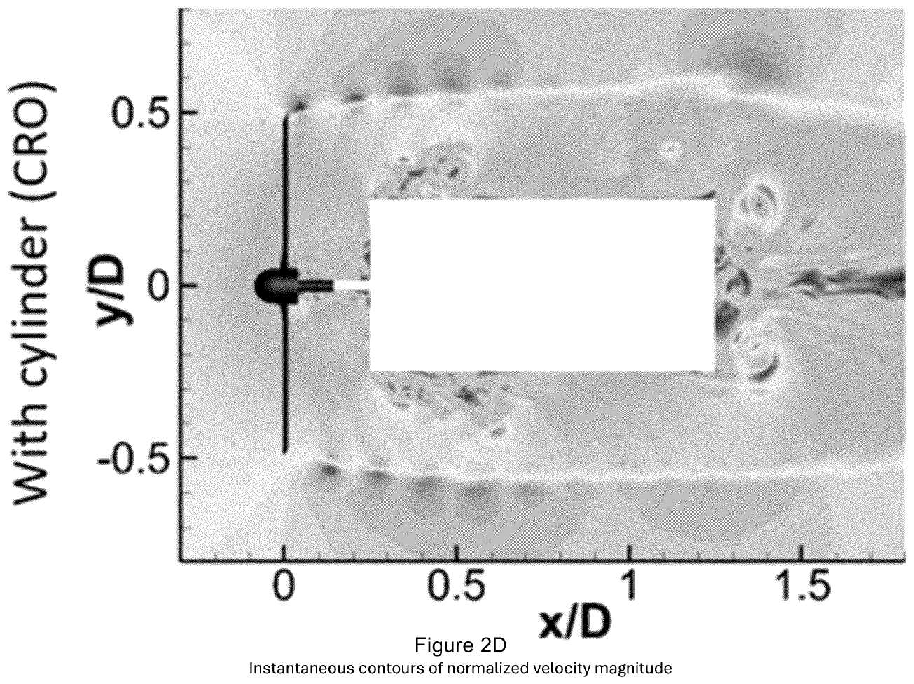

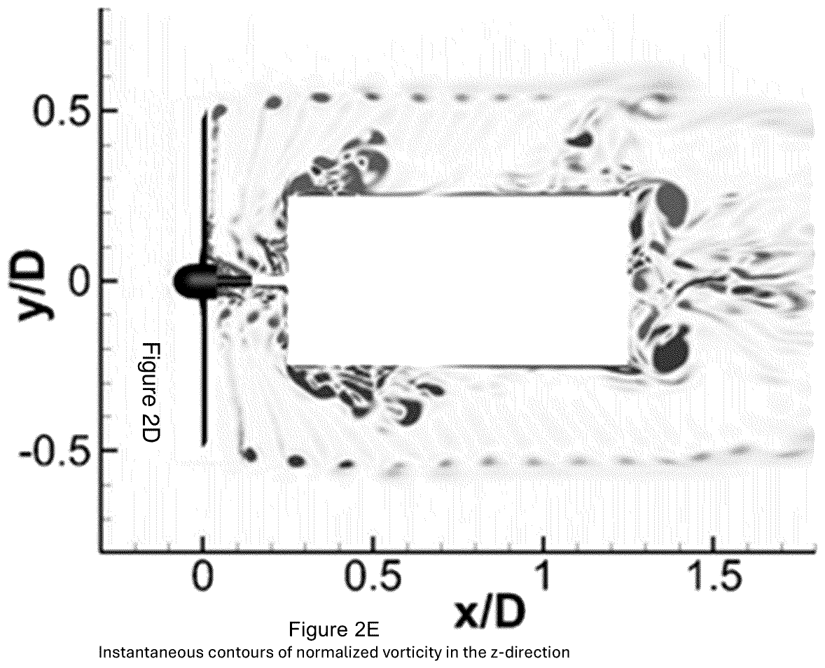

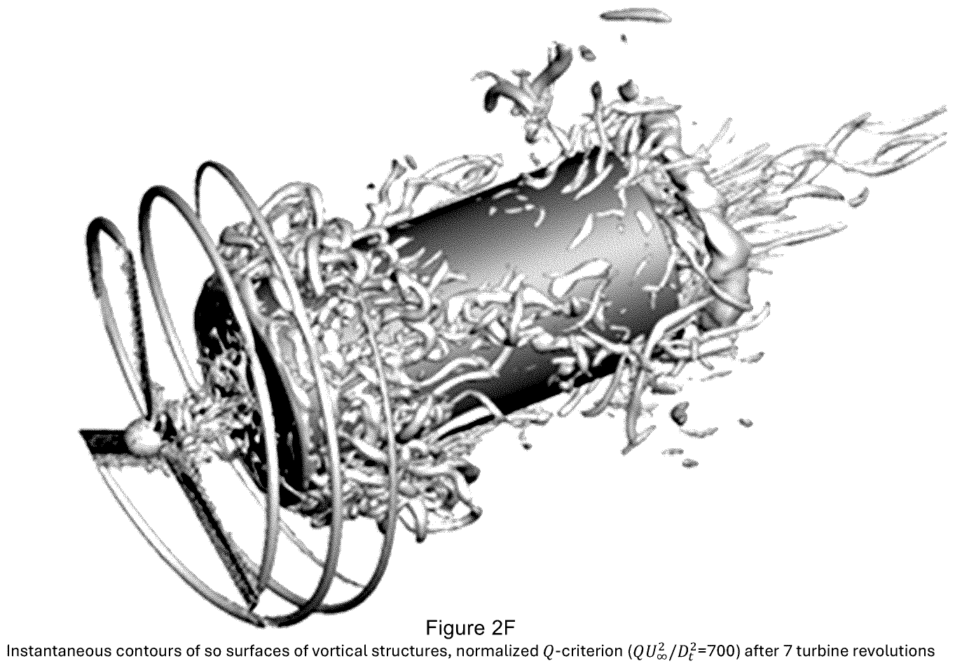

Tidal turbines convert tidal current's kinetic energy to mechanical energy by utilizing rotor blades spun by the motion of tides. Tidal turbines rotate at lower speeds than the CRO module, requiring a gearbox to transmit mechanical power from the rotor shaft to the CRO module. At start-up, the bearing and frictional forces, as well as the inertia of the turbine rotor, pump, and CRO, create resistance to movement. Once the system reaches the desired rotation speeds, the inertial forces decrease and become constant. Any excess power generated will be captured by integrating a regenerative brake with the runner shaft or by storing potential energy in another form, such as a raised reservoir (e.g., a dam, tank, pond, etc.). However, the downstream CRO module impacts the performance and wake hydrodynamics of the turbine through complex interactions between the runner and CRO. Preliminary simulations of a cylinder behind the runner support this, as shown in FIGS. 2A-2F. Additional analysis is required to establish the optimal position and size of the CRO module in relation to the tidal turbine.

In the preliminary Large Eddy Simulations (LES), with high spatial and temporal resolution [28,29], the effect of a downstream empty cylinder (representing a CRO module) on a tidal turbine's (1:20 scale model) performance and hydrodynamics is investigated. The simulations are conducted at the bare turbine's best efficiency point, with a free stream velocity of 0.73 m/s and a turbine rotation speed of 250 rpm [22], and a blockage ratio of less than 5%. FIGS. 2A, 2B and 2C shows helix-shaped vortices near the tip and wake, with blade roots and hub generating vortices extending to a quarter of the diameter. FIGS. 2D, 2E and 2F show that helix-shaped vortices with an added downstream cylinder obstruct flow and shift tip vortices to a larger diameter. Moreover, the tip vortices dissipate earlier and the cylinder sheds vortices interacting with tip vortices. Smaller flow structures occupy the leading circumference of the cylinder, while larger vortex roll-up and elongated vortices in a streamwise direction were found along the trailing circumference. The power coefficient reached a steady state after seven revolutions of the turbine. Experiments showed a power coefficient of 0.34 without the CRO, while LES simulations gave 0.32, with a 7% discrepancy. Adding a downstream cylinder decreased the power coefficient by around 30% (0.32 to 0.22), highlighting the need for further research to optimize the size and location of the CRO. The best operating conditions for the bare turbine may not be optimal for the turbine with a cylinder, requiring additional experiments and simulations.

Key factors to consider when assessing a potential site for a ITTCRO include current consistency and speed, water depth, seabed bathymetry, and the surrounding marine environment. Tidal turbine power output increases significantly with small increases in current speed, as it is proportional to the cube of the speed. Choosing a site with strong and consistent currents is critical to maximize turbine energy output and ensure predictable and reliable power generation, enabling consistent water production from the proposed technology. The power output of a turbine increases quadratically with its diameter. Larger water depths enable the operation of bigger turbines and prevent the interaction of the turbine with the water surface which can decrease turbine performance [9] and cause structural issues. The complex seabed bathymetry can alter current speed and direction, leading to unsteady loading across the turbine's diameter, wear, and reduced performance.

Studies comparing CFD analysis and experiments for HKT performance mostly show good agreement. In a recent study, the error between numerical predictions and experimental results was found less than 3.0% at the turbine's design point when accounting for losses [21]. Banerjee et al. [21,22], [23], [24,25] conducted experiments and simulations at their tidal turbine facility to investigate turbine performance in various conditions, including yaw angles and free surface proximity. They also obtained a good agreement between the simulations and experiments.

The performance of individual turbines in hydro- or wind farms can significantly impact the overall energy output and efficiency of the farm [7,26]. Understanding wake effects and turbine interactions is essential to maximize energy production while minimizing wake losses. Riglin et al. (2016) [7] compared the relative power of propeller-based hydrokinetic turbines configured side by side or upstream-downstream. In the inline upstream-downstream configuration at an axial distance of 6Dₜ between the turbines, the upstream turbine performance was not affected while the downstream turbine had an 83% drop in power which is comparable to the 71% power reduction in the experiments of Mycek et al. with conventional HKTs. These apply to the technology of the integrated tidal turbine and CRO module, where the interaction between the two should be studied to avoid downstream cylinder (i.e. CRO) interference with the turbine.

OpenFOAM, an open-source software, or other commercial software such as Ansys-Fluent, ANSYS-CFX and STAR-CCM+ may be used to conduct simulations of tidal turbines with and without a cylinder.

CRO technology is a type of water desalination technology that uses centrifugal force to separate salt from water. The system works by spinning a single or a series of cylindrical modules at high speeds, creating a centrifugal force that separates the water from the salt. The continuous water permeation through the membrane results in an increase in salt concentration that is aligned with the increase in centrifugal pressure in the same direction. The CRO harnesses this gradual increase in pressure to enable the system to operate with thermodynamic minimum energy. See, W. Krantz and T. Chong, WO 2021/071435 (15 Apr. 2021).

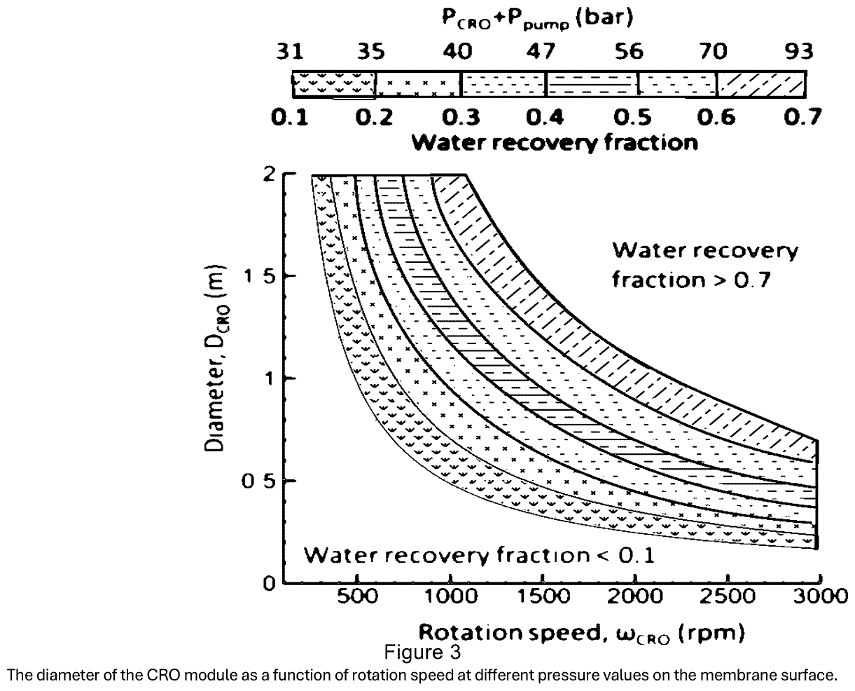

The centrifugal pressure developed inside the CRO module, P_{CRO}, is a function of the rotation rate ω_{CRO} and the diameter D_{CRO} as P_{CRO}˜ω_{CRO}²D_{CRO}². There is no thermodynamic advantage in using angular acceleration to increase the centrifugal pressure if no permeation can occur. Therefore, the feed is pre-pressurized up to osmotic pressure levels (e.g., 28 bar for the 35 g/L feed) using a pump (Pₚᵤₘₚ) coupled to the turbine shaft. The diameter of the CRO module as a function of rotation rate for different total pressure and water recovery fraction values is shown in FIG. 3. Assuming a potable water recovery rate of 50%, the total pressure should be around 56 bars [2]. The system can attain 56 bar by utilizing a pump providing 28 bar and a CRO module with a diameter of 1.0 m and a rotational speed of 1400 rpm (FIG. 3).

Table 1 shows the SECₙₑₜ (kWh/m³) as a function of fractional water recovery for conventional RO and CRO for a 35 g/L seawater feed, from [1]. At all fractional water recoveries, the CRO exhibits a lower SECₙₑₜ than conventional RO. For example, at a water recovery fraction of 0.5, which is typical for commercial seawater RO operations, the CRO reduces the SECₙₑₜ by 31% and SEC_{gross} by 15.4% [1]. The use of current commercial membranes that can withstand high pressures up to 84 bar, allowing for a recovery rate of 0.67, results in a 45% reduction in SECₙₑₜ through the application of CRO. Under idealized conditions assuming local thermodynamic equilibrium, the calculations do not consider the impact of concentration polarization, scaling, fouling, or pressure drops within the module. Chong and Krantz [6] estimated the energy-efficient reverse osmosis (EERO) process with the same approach, which was later validated through pilot-scale experiments at the Singapore Membrane Technology Center, showing good agreement between model predictions and experimental results, with a difference within 20% for operation at the thermodynamic limit.

TABLE 1
SECₙₑₜ (kWh/m³)

| Fractional Water | Centrifugal Reverse | |
|---|---|---|
| Recovery | Osmosis | Reverse Osmosis |
| 0.20 | 0.80 | 1.00 |
| 0.25 | 0.83 | 1.05 |
| 0.30 | 0.86 | 1.10 |
| 0.35 | 0.90 | 1.25 |
| 0.40 | 0.94 | 1.32 |
| 0.45 | 0.99 | 1.40 |
| 0.50 | 1.04 | 1.50 |
| 0.55 | 1.10 | 1.70 |
| 0.60 | 1.17 | 1.90 |
| 0.65 | 1.25 | 2.20 |
| 0.70 | 1.35 | 2.5 |

Dynamic filtration uses rotating membranes or impellers to increase permeate flux and reduce concentration polarization. High shear rates can be achieved in RO by increasing velocity parallel to the membrane or reducing channel thickness, which is energy-intensive and reduces transmembrane pressure [13]. Early systems created Couette flow between a cylindrical membrane rotating inside a concentric cylindrical housing to obtain Taylor vortices [14], which increased the shear rate beyond that of classical Couette flow. The Dyno module adopted multi-disk membranes to enhance the effective membrane surface area with diameters from 13.7 cm to 85 cm and a maximum pressure of 6 bar [13]. SpinTek Filtration also adopted rotating disk membranes for a microfiltration system [15]. The operating pressure of dynamic filtration systems, excluding vibrating systems, does not exceed 15 bar, which is essential for RO [13].

Desalination modeling is complex due to interactions between feed and membrane, asymmetric concentration accumulation, and turbulence caused by feed channel spacers. One-dimensional or algebraic models cannot accurately predict permeate flux. Usta et al. developed a computational model [16,17] for reverse osmosis desalination that solves spatiotemporal flow structures and NaCl concentration using two models: solution-diffusion membrane flux and SST k-@ turbulence flow. The model was validated by comparison to the experimental measurement of permeate flux [18]. The model was also expanded to include membrane distillation and temperature fields, with accuracy verified against experiments [19]. They also used a data-driven approach to tune low-fidelity models with a machine-learning algorithm trained on high-fidelity solutions [20]. This allows for the use of low-fidelity simulations for larger systems.

Previous studies used rotation to generate total pressure, resulting in equivalent performance to conventional RO modules. However, the CRO adopted herein [1] takes advantage of the fact that centrifugal pressure increases continuously with radial distance, allowing for a continuous increase in transmembrane pressure and approaching local thermodynamic equilibrium. The closed-circuit reverse osmosis (CCRO) process, which involves continuously recirculating the brine and incrementally increasing the pressure on the retentate side as the concentration rises due to permeation, also approaches operation near the thermodynamic limit [30]. Desalitech Ltd. (Dupont) commercialized CCRO in 2009. Although the CCRO is attractive, it is limited to small-scale applications due to its semi-batch nature, frictional losses, and heat-of-mixing losses. The CRO module operates continuously without recirculating the feed, making it suitable for both small- and large-scale RO applications and avoiding the limitations of the CCRO mentioned above.

CRO systems have a shorter retentate channel length compared to traditional RO systems, which reduces the likelihood of scaling. In RO, the feed water can flow through multiple membrane modules up to 24 ft long, whereas CRO feed water flows in the radial direction and is limited to the CRO module's diameter, resulting in a retentate channel length of less than 1-2 ft. The maximum outer diameter of the membrane stack in CRO systems is dictated by the rotational speed and recovery rate. A 50% recovery rate necessitates a 56-bar pressure, which can be attained by rotating the module with a radius of 0.5 m at 2800 rpm. A study by Benecke et al. showed that scaling mass linearly increases towards the retentate outlet. This suggests the shorter channel length of CRO systems makes them less prone to scaling.

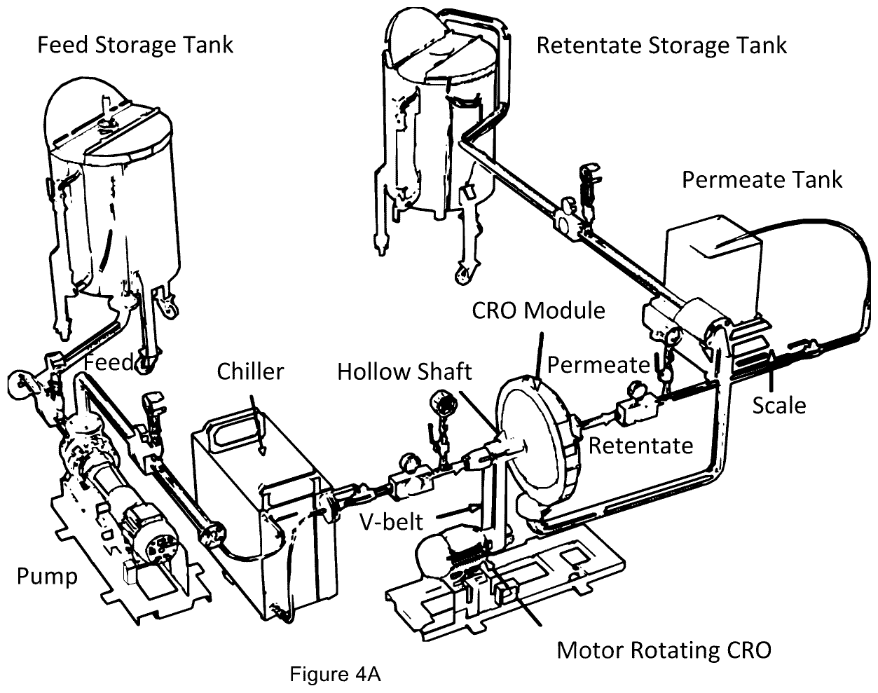

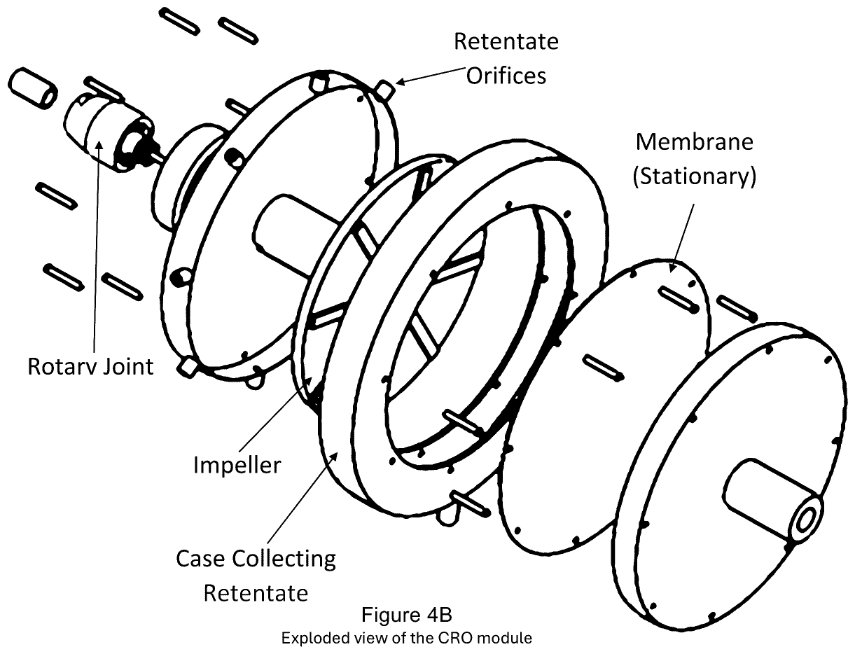

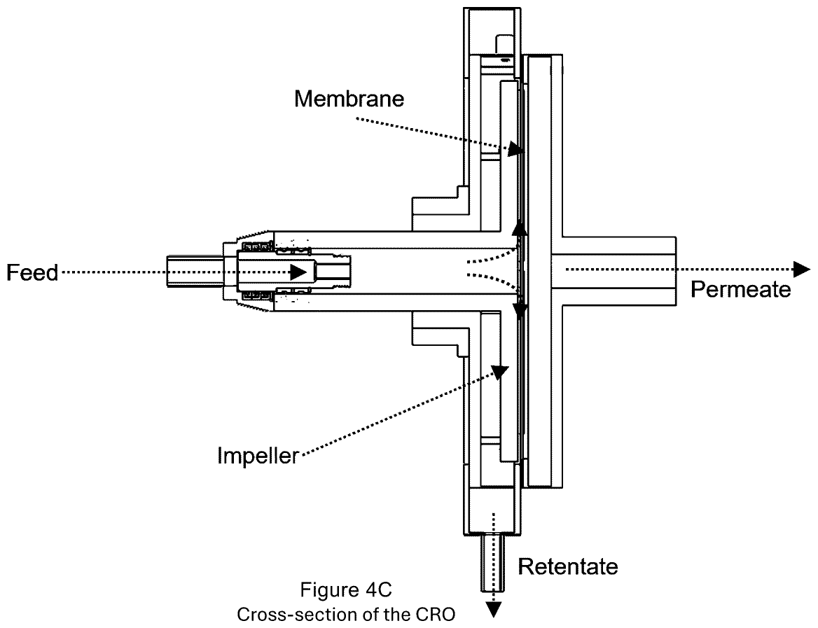

A system for testing the CRO includes a storage tank, flow meters, a high-pressure pump, a chiller, a cylindrical test module, and a servo motor (FIG. 4A). A FilmTec disc-type polyamide-TFC membrane or another one may be used in the CRO unit for high rejection rates. A digital interface may be used to accurately measure flux through the membrane. Data from sensors may be collected at 100 Hz, though some data may be collected above the rotational rate of the filter, e.g., 10 kHz, and other data may be collected to capture an expected transient response to changes in inlet composition, e.g., seconds or longer. The chiller may be used to regulate feed temperature, and the servo motor may be adapted to rotate the CRO module for accurate testing under realistic saltwater conditions.

One potential design for the CRO module is shown in FIGS. 4B and 4C. In this design, feed enters the CRO module through a hollow shaft that is driven by a servo-motor (emulating the integral tidal turbine in the ITTCRO) through a V-belt. After entering the module, the feed moves radially and tangentially due to the centrifugal pressure and shear generated by the impeller's rotation, while all other parts remain stationary. The permeate flows across the disk-shaped membrane from the axis-of-symmetry of the module and are collected in a container for weight measurement. The retentate is discharged from the orifices around the periphery of the stationary case and collected at another stationary case around the module. To maintain pressure inside the feed channel, back pressure is created through the orifices discharging the retentate. The retentate is collected in a separate storage tank from the feed tank to obtain and use the retentate salinity for post-experiment calculations.

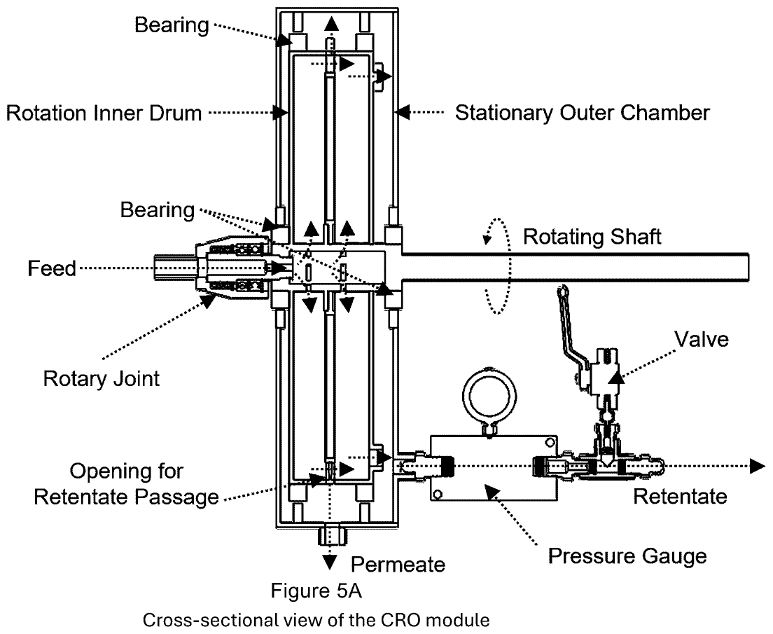

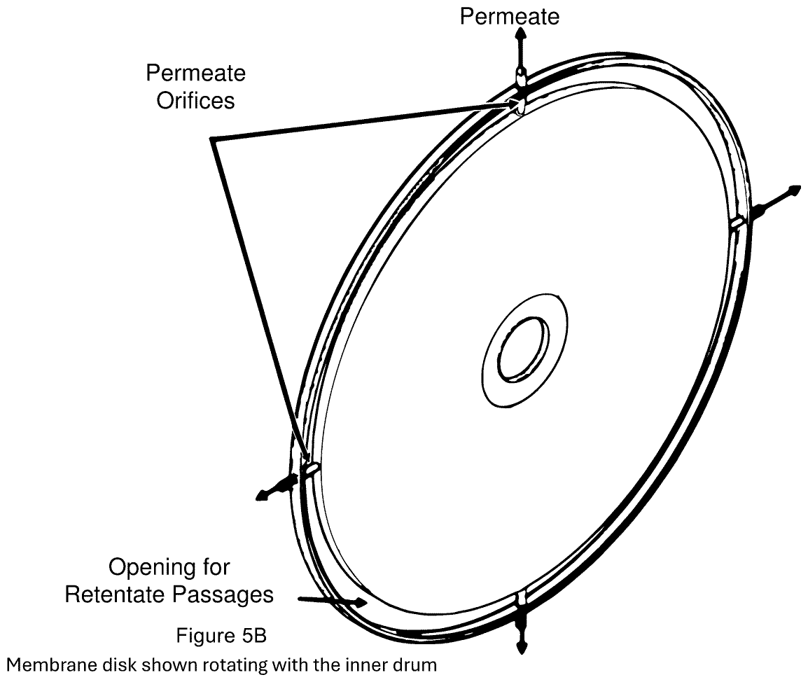

In an alternative design depicted in FIGS. 5A and 5B, the disk membrane and inner drum are rotated using a shaft that can be directly connected to the tidal turbine, eliminating the need for a V-belt. Outside of the inner drum, an outer chamber is employed to gather both the permeate and retentate. The bearings that connect the rotating and stationary parts are waterproof. The feed enters the inner drum from the opposite side through a hollow shaft and undergoes both radial and tangential movement as a result of the centrifugal forces generated by the inner drum's rotation. Once the flow inside the inner drum has reached a pseudo-steady state, its motion resembles that of a solid body rotation. The permeate flux occurs across the disk-shaped membrane while the feed is moving in the radial and tangential directions. The membrane disk is enveloped by membrane sheets on both sides, with a permeate channel situated between these membrane sheets. The permeate orifices, located at disk's outermost diameter, transport permeate into the annular space enclosed by the bearings, inner drum, and outer chamber. Subsequently, it is discharged from the outer chamber at atmospheric pressure through another orifice. The membrane disk features an axial opening near its outermost diameter, alongside permeate orifices located near the outer surface of the inner drum. These elements facilitate the axial movement of retentate within the retentate channels. The orifices at the outmost diameter of the inner drum discharge retentate to the axial space between the inner drum and outer chamber. To regulate the pressure within the feed channel, a valve is attached to the outlet of the stationary chamber where the retentate is discharged. In this design, an increase in back pressure requires the accumulation of retentate within the axial space between the inner drum and outer chamber. This accumulation can lead to shear forces on the surfaces of the rotating inner drum, which can be mitigated by employing an alternative design.

The system's capabilities may be examined by exposing it to feed pressure of up to 60 bar, with over 50% recovery using a positive displacement pump. The system operates at high pressure to desalinate a feed containing up to 35 g/L NaCl in conventional RO mode. Moreover, the CRO module will be vibration and safety tested by rotating up to 3000 rpm.

The CRO design utilizing a single or multiple disk membranes between the feed and permeate channels, requires 56 bar pressure to obtain 50% water recovery from seawater. Based on idealized calculations, a CRO module with a diameter of 0.5 meters can reach a total pressure of 56 bar at its outer radius when rotated at 2800 rpm, with pre-pressurization to 28 bar via a conventional pump. In testing, synthetic seawater with salinity increasing gradually up to 35 g/L by only adding NaCl and adjusting the pH to 7.6 to simulate seawater is utilized. The pre-pressure level is adjusted based on the feed salinity to ensure it does not surpass the osmotic pressure, ensuring that all the permeate flux is due to differential pressure caused by centrifugal forces. The CRO module may be tested at different salinity levels (such as 10, 20, 35 g/L), and permeate flux measured.

A computational model can accurately model the CRO membrane separation process, taking into account concentration polarization and fouling. The solver uses three-dimensional mass and momentum transfer simulations and integrates local mass concentration with membrane flux. The Solution-Diffusion model calculates local flux, taking into account membrane permeability and pressure. OpenFOAM is used as an open-source tool for the simulations, as it has previously been shown to successfully reproduce experimental permeate flux in conventional reverse osmosis modules.

The computational model can simulate the feed flow conditions to predict the permeate flux. The simulations focus on the initial flux and will also generate the radial profile of flux, which is used for determining the thermodynamic efficiency of the CRO system. This profile is used to assess the separation efficiency of the system, and the simulations provide insights into the effectiveness of the gradually increasing transmembrane pressure in the feed flow direction. By comparing the predicted permeate flux with the experimental data, the computational model is validated and then further useful in optimizing the CRO design.

The computational model may be used to characterize the CRO module at different operating conditions, for example, the flux conditions at different flow rates and operating conditions. The effects of varying flow rates on the flux, taking into account the changing wall shear profile due to the increasing channel cross-sectional area in the radial direction may be determined. Likewise, the effects of spacers in the retentate channel may be determined. Spacers obstruct the flow and induce mixing, which affects the mass transport dynamics and can result in both alleviation of concentration polarization and an increase in pressure drop. While a single type of filter may be standardized, greater flexibility in filter design and selection results from including this as a variable within the computational model. The accuracy of fast, time-averaged solvers (i.e. Reynolds-Averaged Navier Stokes) may be validated with highly resolved solvers (i.e. Large-Eddy Simulations) in a smaller domain. The time-averaged solver may be used to understand the flow and separations dynamics in the whole domain.

The current state-of-art for using tidal turbines in desalination involves directly integrating a high-pressure pump with the shaft of the tidal turbine runner, which rotates the pump to generate pressurized water for the RO process. While this method avoids energy conversion losses, it still pressurizes the same conventional RO unit. The ITTCRO technology brings several innovations to advance this state-of-the-art for integrated tidal desalination system.

Ocean waves and tides can supply mechanical energy directly or indirectly to drive desalination systems via marine energy converters. Direct powering avoids conversion losses by pressurizing the system without generating electricity. Early attempts to use wave energy to power the RO module directly included the DELBOUY system, which used a linear pump driven by waves without motors, generators, or electronics [31]. Another concept, AaltoRO, converted wave energy into hydraulic energy to pressurize seawater directly [31]. Yu and Jenne demonstrated the direct conversion of wave energy into high-pressure flow to pump saltwater to the RO unit, reducing water cost by eliminating the power conversion. The “Waves to Water Prize” spurred innovation in modular desalination systems powered by wave energy, with some using hydraulic pressure from wave energy in desalination [32]. Wind-driven desalination typically involves converting wind energy into electricity to power the units. However, similar to the “hydraulic wind turbines” [33], integrating centrifugal pumps into rotating tidal turbines provide options that avoid electrical conversion losses. However, these concepts are largely limited to numerical studies [34-36], except for the experiments conducted by Zhao et al. in which the conventional RO module was pressurized directly. In their study, a 1.1-meter diameter tidal turbine provided a pressure of 35 bar at a current velocity of 1.0 m/s. However, the technology still employed conventional RO modules, and used tidal power to generate pressure and not a direct mechanical linkage to the RO module.

The ITTCRO technology not only eliminates conversion losses in electricity but also enhances compactness by directly integrating the more efficient CRO module onto the rotor shaft or transmission.

For many years, the conventional RO approach has been the leading technology to desalinate seawater. It operates by applying pressure higher than osmotic pressure to a selective membrane that results in a permeate flux through the membrane. The osmotic pressure locally changes by local recovery rate. In conventional RO regardless of this fact, the retentate is pressurized to the target pressure which causes a major deviation from thermodynamic efficiency. The ITTCRO technology offers efficient use of marine energy for desalination:
(a) energy efficient operation of CRO module near the thermodynamic limit,
(b) elimination of electrical conversion and direct use of mechanical power from the hydrokinetic turbine,
(c) potential for system cost reduction by direct integration of the hydrokinetic turbine and CRO,
(d) potential for decreasing scaling as retentate channels are much shorter.

Validation of the models adopted for the simulations of the tidal turbine and CRO module enables the characterization of its operation at various flow conditions. This may lead to a ‘computational framework’ developed through machine learning algorithms, such as neural networks, deep neural networks, etc., which can be used to determine optimum rotation speed, pressure, and flow rates based on varying flow conditions on the site. The computational framework may be used as part of a model-based controller for controlling all or a portion of the system. The inputs may include water flow velocity and variability, weather forecast, tide schedule, time of day, water demand, system status, and history. The outputs may include water flow controls, turbine pitch angle, transmission control/CRO rotational speed, braking, control over hybrid elements; control over treated water reservoir, etc., as may be appropriate for the system implementation. Moreover, the deviation of the system performance, which can be detected by comparing the system output to the expected output within the computational framework, may be indicative of membrane fouling, bearing wear, seal condition, etc. The computational framework may thus be used as part of a predictive maintenance system, in addition to a run-time control system. The integrated tidal turbine (hydrokinetic turbine) may have external controls to limit seawater influx, and these may be controlled by the computational framework to ensure adequate available power, without exposing the system to damaging peak power or transients.

The computational framework may be embedded in an automated control, which may include a microprocessor, memory, persistent storage medium, sensor inputs, actuator control outputs, and a communication port. The controller may be adaptive, i.e., have an updated control algorithm dependent on the system's past performance. Thus, as the membrane fouls, or before remediation, the operating pressure may be increased as required to achieve the required performance. The automated control may report maintenance status through the communication port to a remote server, such as a cloud-based facility, which can then schedule maintenance as necessary or predictively.

The system has various wearing or degrading parts, and therefore assuming that the ITTCRO has a high peak capacity, the automated control may be used to predict demand for desalinated water and limit production to the amount required and replenishment of any reservoir. Likewise, the automated control can manage the reservoir level based on predicted demand and any limits on production, such as diurnal variations, weather-based variations or interruptions, etc. Similarly, the system may include an electric motor drive as a backup for the failure of the TT/HKT, and in some cases, a conventional RO system receiving pressurized seawater instead of the CRO in the event of its unavailability. The automated controller may control all of these variations and options.

In some cases, the ITTCRO system have unit-to-unit variations, which require tuning individual installations. While it is preferred to define the operation of the system using logic and equations/algorithms, machine learning may be employed to define the operation. For example, a neural network may be trained using an objective function such as “total cost of operation, including energy, human services, and consumable supplies” per unit of desalinated water. These variables may be measured from an exemplar or test installation, or the actual installation to be controlled. In the latter case, the costs may require some time to become known, but may better compensate for actual geographical differences. On the other hand, the exemplar (factory) trained system will better operate after installation. Therefore, a strategy is to provide a generically trained system that is adaptive as real data is obtained, using automated (e.g., sensor-based) and/or manual (e.g., technician inputs) data entry.

In some installations, there may be unique or unexpected requirements, and in general, the saltwater desalination equipment represents a capital investment that persists for years or decades. Therefore, the control system is preferably modular, allowing the replacement of all or portions of the system if and when they become antiquated. The control system may be overprovisioned, and have unused generic capabilities, in case expansion or extension of an existing installation is required.

The ITTCRO may include an auxiliary generator to generate electricity when the tidal power exceeds the amount necessary for desalination. The generator further provides a control for the ITT, allowing dynamic speed control within milliseconds. Further, a motor-generator may also provide power to maintain the required speed even during an interruption of tidal power. For this purpose, a battery, i.e., lithium-ion, may be provided. Advantageously, the motor-generator, battery, speed control logic, etc., may be similar to the drivetrain of an electric vehicle. Thus, for example, the electrical motor-generator may be a 350 HP motor, connected through a controller to a 400 V lithium-ion battery. The battery may provide power for local electrical components of the system, and excess power provided as a utility. This may be especially useful given that a particular use case for the ITTCRO system is to ensure that clean water is available during power outages.

The ITTCRO may have a storage tank or reservoir above the inlet of the turbine, which receives a flow of water, e.g., seawater, from a pump driven by the turbine, generally a different pump than pre-pressurizes seawater entering the CRO, because of differences in flowrate/volume characteristics. The pumped water develops a pressure head, that can be or is later used to drive the turbine when there is insufficient natural water flow to run the turbine to achieve a desired filtration rate from the CRO. Because the turbine is driven from natural seawater flows, the tank is generally a low pressure tank which stores a large volume of water, to provide a durable energy reserve. The reservoir may be a natural or artificial structure, and for example may be 2-10 feet above sea level.

In cases where the tidal power exceeds the amount for the desalination in a single CRO unit, multiple CRO units can be operated using a single tidal turbine power.

Multiple CROs can be arranged either side by side or back-to-back in the wake of the tidal turbine to prevent flow blockage and minimize its adverse impact on tidal turbine hydrodynamics.

Apart from operating underwater, the CRO module(s) can also be positioned above the water surface, floating on a base. This could potentially mitigate the influence of the CRO module on turbine hydrodynamics and performance based on the method used for power transmission.

An integrated motor-generator system could also be employed to assist in the start-up of the ITTCRO system which ensures a more reliable start-up process until the CRO reaches its rotation speed.

Further, the automated control system may coordinate the operation of a bank of ITTCRO systems, with the automated control determining which of the systems in the bank should be operated, at what speeds, and other operational variables that may be interactive between the units in the bank. The automated control system may be distributed, e.g., each ITTCRO has its own controller, with communications between them that permit coordination, fault tolerance, and task sharing.

In some cases, the controller employs a decentralized ledger or blockchain technology as part of its data reporting, authentication, and updating technology. For example, a controller may determine authentication credentials for remote access from a blockchain. Operational data may be reported to a blockchain, optionally in encrypted form. This blockchain technology provides fault tolerance in the network, non-repudiation, authentication, and in some cases, the ability to execute smart contracts. A smart contract, for example, may be used by to coordinate financial elements of the system, such as sale of water, payment for service and consumables, lease payments for a capital equipment funder, etc.

Hydrokinetic turbines, both with and without a cylinder mimicking the CRO, can be evaluated at smaller scales in circulating water tunnel facilities or by employing a towing system in a calm water tank. This approach helps in assessing their performance characteristics across various operating conditions and validating the CFD simulations which can be later used for the simulations of full-scale ITTCRO systems. To measure the loads experienced by the rotor, a sensor assembly consisting of a thrust and a torque sensor will be placed within the nacelle. The turbine nacelle is pressurized to prevent water ingress into the sensor assembly. The torque and thrust loads may be measured at a sampling rate of 200 Hz for approximately 120 s.

Flow-field visualization may be employed using the stereoscopic PIV technique to determine the key flow mechanisms induced by the downstream cylinder contributing to changes in turbine performance. These measurements provide baseline data, and similar measurements may be used during use of the ITTCRO. The PIV measurements are taken at the best efficiency point or off-design operating conditions for the bare turbine and the turbine with the cylinder. The two or three-dimensional PIV system is used to characterize wake structures, and tip and hub vortices in the flow field. The results from the experiments where the turbine has variable tilt blades, the real-time measurements of flow dynamics may be used to control the blades, in conjunction with the performance of the CRO system. For example, the hydrokinetic turbine may have a preceding baffle, variable pitch rotor, motor-generator controlling speed and drag, etc., providing multiple available control parameters.

The ITTCRO may be tested in a small scale, which is then used for the validation of the numerical simulations. The validated computational models can be used for full scale ITTCRO. Large eddy simulation (LES) turbulence model along with a dynamic k-equation subgrid-scale (SGS) model may be adopted for the simulations of the bare turbine and turbine with the cylinder at various operating conditions.

The validated LES model may be used to investigate the influence of the cylinder on the performance of a full-scale turbine. The impact of cylinder diameter and the turbine-cylinder distance may be determined at different D_{cro}/Dₜ ratios (0.1, 0.3, 0.5) and s/Dₜ ratios (0.25, 0.5, 1.0). The simulations may be performed at varying operating conditions for each configuration to determine the turbine's best efficiency point to use in the aforementioned computational framework. The simulation output may be adjusted to incorporate the bearing and frictional losses not considered in CFD. This mimics the integration of the CRO module with a tidal turbine, aiding us in demonstrating proof-of-concept.

Data from simulations of a full-scale turbine may be used to carry out experiments on a CRO module with a single membrane layer rotated by a servo motor. This involves measuring both permeate flux and energy consumption at a rate of e.g., 100 Hz. This builds on the evaluation of the experimental setup for different rotational speeds of the CRO module, but with a realistic torque input from a full-scale turbine, to determine whether the turbine power output is sufficient to operate the CRO module and to assess the water recovery rate that can be achieved with the single-disk CRO, given the turbine power.

A full-scale CRO module that contains multiple membrane layers in a series configuration along the axial direction is then simulated. Realistic operating conditions from the full-scale turbine are used to determine the maximum achievable water recovery rate from the CRO module with a given power input from the turbine.

Therefore, the technology provides not only the ITTCRO, but also an advanced computational framework for turbine and CRO modeling, including HKT-CRO hydrodynamics. Those skilled in the relevant art(s) will readily appreciate that various adaptations and modifications of the exemplary embodiments described above can be achieved without departing from the scope and spirit of the present disclosure. Therefore, it is to be understood that, within the scope of the appended claims, the teachings of the disclosure may be practiced other than as specifically described herein.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references, the inventors' prior publications relating to the field, academic literature in the field, commercial literature in the field, field-specific dictionaries, lay literature in the field, general purpose dictionaries, and common understanding. Where the issue of interpretation of claim amendments arises, the hierarchy is modified to include arguments made during the prosecution and accepted without retained recourse.

### REFERENCES

References (each of which is expressly incorporated by reference in its entirety):
[1] Krantz, William B., and Tzyy Haur Chong. “Centrifugal reverse osmosis (CRO)—a novel energy-efficient membrane process for desalination near local thermodynamic equilibrium.” Journal of Membrane Science 637 (2021): 119630.
[2] W. Krantz and T. Chong, PCT Patent WO 2021/071435 (15 Apr. 2021).
[3] Y. H. Yu and D. Jenne, in ASME-OMAE (2017).
[4] A. LiVecchi et al., Powering the Blue Economy: Exploring Opportunities for Marine Renewable Energy in Maritime Markets: Desalination, Chapter 7, 2019.
[5] E. Lantz, D. Olis, and A. Warren, U.S. Virgin Islands Energy Road Map: Analysis, 2011.
[6] T. Chong and W. K. Desalination, Desalination 443, 70 (2018).
[7] Riglin, J., Daskiran, C., Jonas, J., Schleicher, W. C. and Oztekin, A., Hydrokinetic turbine array characteristics for river applications and spatially restricted flows. Renewable energy, 97, pp. 274-283 (2016).
[8] A. Alhadidi, A. J. B. Kemperman, J. C. Schippers, M. Wessling et al., Desalination Water Treat 42, 43 (2012).
[9] B. Attiya, P. C. Rossin, M. Altimemy, C. Daskiran, I.-H. Liu, and A. Oztekin, in ASME-IMECE (2019).
[10] C. J. Fox, S. Benjamins, E. A. Masden et al., Renewable and Sustainable Energy Reviews 81, 1926 (2018).
[11] Cruise Lines International Association. “State of the cruise industry outlook.” (2020).
[12] O. J. A. Howitt, V. G. N. Revol, I. J. Smith, and C. J. Rodger, Energy Policy 38, 2552 (2010).
[13] M. Y. Jaffrin, J Memb Sci 324, 7 (2008).
[14] M. Y. Jaffrin, Annu Rev Fluid Mech 44, 77 (2011).
[15] W. A. Greene, P. A. Kirk, R. Hayes, and J. Riley, Centrifugal Membrane Filtration, 2005.
[16] M. Usta, A. E. Anqi, and A. Oztekin, Desalination 416, 129 (2017).
[17] M. Usta, M. Morabito, A. Anqi, M. Alrehili, A. Hakim, and A. Oztekin, Desalination 441, 21 (2018).
[18] C. K. Ho, S. J. Altman, H. D. T. Jones, S. S. Khalsa, L. K. McGrath et al., Environmental Progress 27, 195 (2008).
[19] A. E. Anqi, M. Usta, R. Krysko, J. G. Lee, N. Ghaffour, and A. Oztekin, J Memb Sci 596, 117609 (2020).
[20] M. Usta and A. Tosyali, in ASME-IMECE (2019).
[21] A. Vinod, C. Han, and A. Banerjee, Renew Energy 175, 840 (2021).
[22] A. Vinod and A. Banerjee, Appl Energy 254, 113639 (2019).
[23] N. Kolekar, A. Vinod, and A. Banerjee, Energies 12, 3325 (2019).
[24] N. Kolekar and A. Banerjee, Appl Energy 148, 121 (2015).
[25] P. K. Modali, A. Vinod, and A. Banerjee, Renew Energy 177, 482 (2021).
[26] C. Daskiran, J. Riglin, A. Oztekin, and P. C. Rossin, in ASME-IMECE (2016).
[27] P. Mycek, B. Gaurier, G. Germain, G. Pinon, and E. Rivoalen, Renew Energy 68, 876 (2014).
[28] C. Daskiran, J. Riglin, W. Schleicher, and A. Oztekin, Ocean Engineering 129, 291 (2017).
[29] C. Daskiran, B. Attiya, J. Riglin, and A. Oztekin, Ocean Engineering 169, 1 (2018).
[30] D. M. Warsinger, E. W. Tow, K. G. Nayar, L. A. Maswadeh, and J. H. Lienhard V, Water Res 106, 272 (2016).
[31] D. C. Hicks, G. R. Mitcheson, C. M. Pleass, and J. F. Salevan, Desalination 73, 81 (1989).
[32] I. Aranda, A. Fairhart, E. Peiffer, M. Santos, and S. Shamsi, NREL Waves to Water Prize Program: Sensitivity Analysis of Alternative Markets. Engineering for Change, Isle Utilities, 2022.
[33] F. Greco, S. G. J. Heijman, and A. Jarquin-Laguna, Processes 9, (2021).
[34] M. H. Khanjanpour and A. A. Javadi, Energy Convers Manag 231, (2021).
[35] A. Jarquin-Laguna and S. Ordonez-Sanchez, in 11th European Wave and Tidal Energy Conference (2021)
[36] D. Zhou, H. Chen, Y. Zheng, K. Kan, A. Yu, and M. Binama, Energies 12, (2019).
[37] J. Benecke, M. Haas, F. Baur, and M. Ernst, Desalination 428, 161 (2018).
[38] J. Riglin, F. Carter, N. Oblas, W. C. Schleicher, C. Daskiran, and A. Oztekin, Renew Energy 99, 772 (2016).
[39] W Krantz, TH Chong, DJ Chen, “Centrifugal Reverse Osmosis (CRO)—a Novel Process for Achieving Desalination at the Thermodynamic Restriction”, 2019 AIChE Annual Meeting, 2019.
[40] Wild, P. M., G. W. Vickers, and N. Djilali. “The fundamental principles and design considerations for the implementation of centrifugal reverse osmosis.” Proceedings of the Institution of Mechanical Engineers, Part E: Journal of Process Mechanical Engineering 211, no. 2 (1997): 67-81.
[41] Wild, Peter M., and Geoffrey W. Vickers. “The technical and economic benefits of centrifugal reverse osmosis desalination.” Desalination 89, no. 1 (1992): 33-40.
[42] Wild, Peter Martin. “Development, optimization and implementation of the design for a centrifugal reverse-osmosis desalination system.” PhD diss., 1994.
[43] Bergen, A., T. M. Fyles, D. S. Lycon, G. W. Vickers, and P. Wild. “Flux enhancement in reverse osmosis using centrifugal membrane separation.” Journal of Membrane science 176, no. 2 (2000): 257-266.
[44] Riffat, S. B., and Y_H Su. “A novel absorption refrigeration cycle using centrifugal reverse osmosis.” Journal of the Institute of Energy 74, no. 499 (2001): 66-69.
[45] Wild, P. M., G. W. Vickers, and D. A. Hopkin. “Development of a centrifugal reverse-osmosis desalination unit of intermediate scale.” Marine Technology and SNAME News 27, no. 3 (1990).
[46] Prince, Hasib Ahmed, Alperen Turkyilmaz, Cosan Daskiran, Mustafa Usta, and Arindam Banerjee. “Near-Wake Interaction of a Tidal Turbine with an Integrated Downstream Centrifugal Reverse Osmosis Module.” Bulletin of the American Physical Society (2023).
[47] Martinez, Matthew Aaron. “Passively Actuated Vibration to Decrease Membrane Fouling Rate for Centrifugal Reverse Osmosis.” PhD diss., 2018.
[48] Bergen, A., P. M. Wild, N. Djilali, and G. W. Vickers. “Fundamental aspects of centrifugal membrane separation.” Proceedings of the Institution of Mechanical Engineers, Part E: Journal of Process Mechanical Engineering 215, no. 4 (2001): 355-365.
[49] Pharoah, J. G., N. Djilali, and G. W. Vickers. “Fluid mechanics and mass transport in centrifugal membrane separation.” Journal of membrane science 176, no. 2 (2000): 277-289.
[50] Bergen, A., P. M. Wild, T. M. Fyles, and G. W. Vickers. “Centrifugal membrane and density separation: A new spin on membrane fouling.” Membrane Technology 1997, no. 90 (1997): 8-10.
[51] Pharoah, Jon George. “Fluid dynamics and mass transport in rotating channels with application to centrifugal membrane separation.” PhD diss., 2002.
[52] Tu, Qingsong, Tiange Li, Ao Deng, Kevin Zhu, Yifei Liu, and Shaofan Li. “A scale-up nanoporous membrane centrifuge for reverse osmosis desalination without fouling.” Technology 6, no. 01 (2018): 36-48.
[53] Mo, Zijing, Dan Li, and Qianhong She. “Semi-closed reverse osmosis (SCRO): A concise, flexible, and energy-efficient desalination process.” Desalination 544 (2022): 116147.
[54] Su, Xu. “Concentration Polarization and Colloidal Fouling in the Vibration Enhanced Reverse Osmosis Membrane Desalination System.” PhD diss., 2018.
[55] Lycon, David Steven. “Flux enhancement and fouling reduction in a centrifugal membrane process.” PhD diss., 1999.
[56] Completo, Carlos, Vítor Geraldes, Viriato Semião, Marília Mateus, and Miguel Rodrigues. “Centrifugal nanofiltration for small-volume samples.” Journal of Membrane Science 540 (2017): 411-421.
[57] Bergena, A., N. Djilali, T. M. Fyles, G. W. Vickers, and P. M. Wild. “An experimental assessment of centrifugal membrane separation using spiral wound RO membrane elements.” Desalination 154, no. 3 (2003): 225-232.
[58] Keener, Tim C., Narunat Sewiwat, and Thunyalux Ratpukdi. “Turbidity removal by centrifugal microfiltration.” Engineering and Applied Science Research 44, no. 1 (2017): 43-45.
[59] Li, Wende. “Prediction of the Concentration Polarization and the Fouling Formation in Membrane Desalination Processes.” PhD diss., 2019.
[60] Mohamed, Essam Sh, and G. Papadakis. “Design, simulation and economic analysis of a stand-alone reverse osmosis desalination unit powered by wind turbines and photovoltaics.” Desalination 164, no. 1 (2004): 87-97.
[61] Modabber, Hossein Vazini, and Mohammad Hasan Khoshgoftar Manesh. “Optimal exergetic, exergoeconomic and exergoenvironmental design of polygeneration system based on gas Turbine-Absorption Chiller-Solar parabolic trough collector units integrated with multi-effect desalination-thermal vapor compressor-reverse osmosis desalination systems.” Renewable Energy 165 (2021): 533-552.
[62] Eveloy, Valerie, Peter Rodgers, and Linyue Qiu. “Integration of an atmospheric solid oxide fuel cell-gas turbine system with reverse osmosis for distributed seawater desalination in a process facility.” Energy Conversion and Management 126 (2016): 944-959.
[63] Khanjanpour, Mohammad Hassan, and Akbar A. Javadi. “Optimization of a Horizontal Axis Tidal (HAT) turbine for powering a Reverse Osmosis (RO) desalination system using Computational Fluid Dynamics (CFD) and Taguchi method.” Energy Conversion and Management 231 (2021): 113833.
[64] Miranda, Marcos S., and David Infield. “A wind-powered seawater reverse-osmosis system without batteries.” Desalination 153, no. 1-3 (2003): 9-16.
[65] Dehmas, Djamila Abdeslame, Nabila Kherba, Fouad Boukli Hacene, Nachida Kasbadji Merzouk, Mustapha Merzouk, Hacene Mahmoudi, and Mattheus F A Goosen. “On the use of wind energy to power reverse osmosis desalination plant: A case study from Ténès (Algeria).” Renewable and Sustainable Energy Reviews 15, no. 2 (2011): 956-963.
[66] Farsi, Aida, and Marc A. Rosen. “Multi-objective optimization of a geothermal steam turbine combined with reverse osmosis and multi-effect desalination for sustainable freshwater production.” Journal of Energy Resources Technology 144, no. 5 (2022): 052102.
[67] Neris, A. S., G. B. Giannakopoulos, and N. A. Vovos. “Autonomous wind turbine supplying a reverse osmosis desalination unit.” Wind engineering (1995): 325-347.
[68] Ramazanian, Saeed, Mehdi Aliehyaei, Mahmoud Salimi, and Mohammad Mehdi Najafizadeh. “Theoretical and experimental investigation of reverse osmosis (RO) desalination solar system using the solar panel, battery, and water turbine for high-pressure recovery of output brine.” Solar Energy 262 (2023): 111852.
[69] Jarquin-Laguna, Antonio, and Francesca Greco. “Integration of hydraulic wind turbines for seawater reverse osmosis desalination.” In 2019 Offshore Energy and Storage Summit (OSES), pp. 1-9. IEEE, 2019.
[70] Ling, Changming, Yifei Wang, Chunhua Min, and Yuwen Zhang. “Economic evaluation of reverse osmosis desalination system coupled with tidal energy.” Frontiers in Energy 12 (2018): 297-304.
[71] Delgado-Torres, Agustín M., Lourdes García-Rodríguez, and María Jiménez del Moral. “Preliminary assessment of innovative seawater reverse osmosis (SWRO) desalination powered by a hybrid solar photovoltaic (PV)-Tidal range energy system.” Desalination 477 (2020): 114247.
[72] Delgado-Torres, Agustín M., and Lourdes García-Rodríguez. “Off-grid Sea Water Reverse Osmosis (SWRO) desalination driven by hybrid tidal range/solar PV systems: Sensitivity analysis and criteria for preliminary design.” Sustainable Energy Technologies and Assessments 53 (2022): 102425.
[73] Greco, F., and A. Jarquin-Laguna. “Simulation of a horizontal axis tidal turbine for direct driven reverse-osmosis desalination.” Advances in Renewable Energies Offshore; Taylor & Francis Group: London, UK (2018): 181-188.
[74] Okampo, Ewaoche John, and Nnamdi Nwulu. “Optimisation of renewable energy powered reverse osmosis desalination systems: A state-of-the-art review.” Renewable and Sustainable Energy Reviews 140 (2021): 110712.
[75] Leijon, Jennifer, Dana Salar, Jens Engström, Mats Leijon, and Cecilia Boström. “Variable renewable energy sources for powering reverse osmosis desalination, with a case study of wave powered desalination for Kilifi, Kenya.” Desalination 494 (2020): 114669.
[76] Hanafi, Abdalla. “Desalination using renewable energy sources.” Desalination 97, no. 1-3 (1994): 339-352.
[77] Leijon, Jennifer, Johan Forslund, Karin Thomas, and Cecilia Boström. “Marine current energy converters to power a reverse osmosis desalination plant.” Energies 11, no. 11 (2018): 2880.
[78] Feria-Díaz, Jhon Jairo, Felipe Correa-Mahecha, María Cristina López-Méndez, Juan Pablo Rodríguez-Miranda, and Jesús Barrera-Rojas. “Recent desalination technologies by hybridization and integration with reverse osmosis: A review.” Water 13, no. 10 (2021): 1369.
[79] Ling, Changming, Xiaobo Lou, and Yin Zhong. “An Experimental Study on a New High-Efficient Supercharger for Seawater Reverse Osmosis Desalination Driven Directly by Tidal Energy.” Frontiers in Heat and Mass Transfer (FHMT) 16 (2021).
[80] Jarquin-Laguna, A., and S. Ordonez-Sanchez. “Utilising tidal stream energy to drive seawater reverse osmosis desalination processes.” In Proceedings of the European Wave and Tidal Energy Conference, p. 2143. 2021.
[81] Okampo, Ewaoche John, and Nnamdi Nwulu. “Optimisation of renewable energy powered reverse osmosis desalination systems: A state-of-the-art review.” Renewable and Sustainable Energy Reviews 140 (2021): 110712.
[82] Yu, Yi-Hsiang, and Dale Jenne. “Numerical modeling and dynamic analysis of a wave-powered reverse-osmosis system.” Journal of marine science and engineering 6, no. 4 (2018): 132.
[83] Dansoh, Cliff. “The viability of renewable energy and energy storage as the power source for municipal-scale reverse osmosis desalination.” Desalination and Water Treatment 55, no. 11 (2015): 3064-3090.
[84] ZhiYing Zheng, FengChen Li, Qian Li, Lu Wang, WeiHua Cai, XiaoBin Li, HongNa Zhng, “State-of-the-art of R&D on seawater desalination technology”, Chinese Science Bulletin, Volume 61, Issue 21:2344-2370 (2016)∥ Energy Science www.researchgate.net/profile/Feng-Chen-Li/publication/330350093_State-of-the-art_of_RD_on_seawater_desalination_technology/links/5d76eabb92851cacdb2df027/State-of-the-art-of-R-D-on-seawater-desalination-technology.pdf, doi.org/10.1360/N972015-00829.

What is claimed is:

1. A desalination system, comprising:
a turbomachine, configured to convert fluid flow into an axial rotation; and
a centrifugal reverse osmosis module mechanically coupled to the turbomachine, configured to separate water from salt based on the axial rotation.

2. The desalination system of claim 1, further comprising:
a gearbox that couples the turbomachine to the centrifugal reverse osmosis module.

3. The desalination system of claim 1, wherein the centrifugal reverse osmosis module comprises a stationary disk membrane.

4. The desalination system of claim 1, wherein the centrifugal reverse osmosis module comprises a rotating disk membrane.

5. The desalination system of claim 1, further comprising an automated control configured to automatically regulate a rotational speed of the centrifugal reverse osmosis module.

6. The desalination system of claim 1, wherein the turbomachine comprises a tidal turbine, further comprising an automated control configured to control a water flow through the tidal turbine.

7. The desalination system of claim 1, wherein the turbomachine comprises a plurality of turbine blades, further comprising an automated control configured to control a pitch of plurality of turbine blades.

8. The desalination system of claim 1, further comprising a pump configured to pressurize water having a salt concentration to be desalinated by the desalination system to an osmotic pressure required based on the salt concentration.

9. A desalination method, comprising:
supplying a fluid flow to a turbomachine and converting the fluid flow into an axial rotation; and
spinning a centrifugal reverse osmosis module with mechanical power from axial rotation from the turbomachine, to osmotically desalinate salt water.

10. The desalination method of claim 9, further comprising:
altering a ratio of the axial rotation of the turbomachine and a rotational rate of spinning of the centrifugal reverse osmosis module with a gearbox.

11. The desalination method of claim 9, further comprising automatically controlling a rotational speed of the centrifugal reverse osmosis module.

12. The desalination method of claim 9, further comprising automatically controlling a rate of the fluid flow through the turbomachine.

13. The desalination method of claim 9, wherein the turbomachine comprises pitched blades, further comprising automatically controlling a pitch of the blades of the turbomachine.

14. The desalination method of claim 9, further comprising pressurizing the salt water entering the centrifugal reverse osmosis module using a pump, to pressurize the salt water to a pressure above 3 bars and below an osmotic pressure of the salt water.

15. The desalination method of claim 14, further comprising spinning the centrifugal reverse osmosis module to raise a pressure of the salt water to a pressure at or above the osmotic pressure of the salt water, based on a desired water recovery rate.

16. A desalination system, comprising:
a turbine configured to transform fluid flow into a rotation about an axis;
a centrifugal reverse osmosis module configured to spin in response to the rotation about the axis and achieve a desalinated water flow through a desalination reverse osmosis membrane dependent on the spin; and
a mechanical transmission configured to transfer mechanical power from the rotation about the axis of the turbine to spin the centrifugal reverse osmosis module.

17. The desalination system according to claim 16, further comprising an automated control configured to control the rotational speed of the centrifugal reverse osmosis module in response to the fluid flow.

18. The desalination system according to claim 16, further comprising a prefiltration system, configured to receive salt water having solid particulates and to produce a filtrate having reduced solid particulates with respect to the received salt water using power from the fluid flow.

19. The desalination system according to claim 16, wherein the turbine has an inlet pressure, further comprising a vessel configured to store fluid having a pressure above the inlet pressure using excess power from the turbine, and to release a flow of the stored fluid when the inlet pressure is insufficient to achieve a desired water recovery rate.

20. The desalination system according to claim 16, wherein a rotational axis of spinning of the centrifugal reverse osmosis module is perpendicular to the axis of the turbine.
